(19) United States
(12) Patent Application Publication
(10) Pub. No.: US 2006/0139416 A1
(43) Pub. Date: Jun. 29, 2006

(54) Fine droplet ejecting device and ink jet recording apparatus using the same

(75) Inventor: Yusuke Nakazawa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/315,196

(22) Filed: Dec. 23, 2005

(30) Foreign Application Priority Data
Dec. 24, 2004 (JP) 2004-373711
Mar. 2, 2005 (JP) 2005-057317

(51) Int. Cl. B41J 2/09

(52) U.S. Cl. 347/77

(57) ABSTRACT

The fine droplet ejecting device includes a ejection unit having an ejection port, and for continuously ejecting fine droplets by applying an electrostatic force to a solution or ink having an electrical charge containing at least fine particles and a medium, a deflecting unit for deflecting the fine droplets ejected from the ejection unit based on a control signal and a recovering unit for recovering either one of the fine droplets flying straight after being ejected from the ejection unit and the fine droplets having a flight direction deflected by the deflecting unit. The ejection unit may further include a resolution enhancing unit for deflecting the fine droplets in a direction different from the flight direction deflected by the deflecting unit. The device can eject the fine droplets stably at high speed, and can reduce a cost. The ink jet recording apparatus uses the fine droplet ejecting device.

The entire contents of literatures cited in this specification are incorporated herein by reference.

### BACKGROUND OF THE INVENTION

The present invention relates to a fine droplet ejecting device for ejecting fine droplets, and more specifically, to a fine droplet ejecting device for ejecting fine droplets by causing an electrostatic force to act on solution containing at least fine particles and an ink jet recording apparatus using the same.

Conventionally, as a device for ejecting fine droplets, there is known an electrostatic ink jet recording apparatus in which an electrostatic force is caused to act on ink containing charged fine particles to eject the ink, for instance. An ink jet recording apparatus disclosed in JP 10-138493 A (hereinafter referred to a “Patent Document 1”) is known as an electrostatic ink jet recording apparatus such as the above described one.

In FIG. 17, there is shown a schematic view of an ink jet head of the ink jet recording apparatus disclosed in Patent Document 1.

FIG. 17 is a schematic view showing a configuration of an example of the ink jet head of the electrostatic ink jet recording apparatus disclosed in Patent Document 1. In an ink jet head 100 shown in FIG. 17, only one ejection portion of the ink jet head disclosed in Patent Document 1 is conceptually shown. The ink jet head 100 includes a head substrate 102, an ink guide 104, an insulating substrate 106, a control electrode 108, a counter electrode 110, a D.C. bias voltage source 112, and a pulse voltage source 114.

Here, the ink guide 104 is disposed on the head substrate 102, and a through hole (ejection port) 116 is bored through the insulating substrate 106 so as to correspond in position to the ink guide 104. The ink guide 104 extends through the through hole 116, and its projecting tip portion 104a projects upwardly and beyond a surface of the insulating substrate 106 on a side of a recording medium P. In addition, the head substrate 102 is disposed at a predetermined distance from the insulating substrate 106. Thus, an ink flow path 118 for ink Q is defined between the head substrate 102 and the insulating substrate 106.

The control electrode 108 is provided in a ring-like shape on the surface of the insulating substrate 106 on the side of the recording medium P so as to surround the through hole 116 of every ejection portion. In addition, the control electrode 108 is connected to the pulse voltage source 114 for generating a pulse voltage in accordance with image data. The pulse voltage source 114 is grounded through the D.C. bias voltage source 112.

In addition, the counter electrode 110 is disposed at a position so as to face the tip portion 104a of the ink guide 104, and is grounded. The recording medium P is disposed on a surface of the counter electrode 110 on a side of the ink guide 104. That is, the counter electrode 110 functions as a platen for supporting the recording medium P.

During the recording, the ink Q containing fine particles (colorant particles) which are charged in the same polarity as that of a voltage applied to the control electrode 108 is circulated through the ink passage 118 from the right-hand side to the left-hand side in FIG. 17 by a circulation mechanism for ink (not shown). In addition, a high voltage of 1.5 kV for example is continuously applied to the control electrode 108 by the D.C. bias voltage source 112. At this time, a part of the ink Q in the ink flow path 118 flows through the through hole 116 of the insulating substrate 106 due to the capillary phenomenon or the like, and is concentrated at the tip portion 104a of the ink guide 104.

When a pulse voltage of for example 0 V is applied from the pulse voltage source 114 to the control electrode 108 biased at 1.5 kV by the bias voltage source 112, a voltage of 1.5 kV obtained by superposing both the voltages on each other is applied to the control electrode 108. In this state, an electric field strength in the vicinity of the tip portion 104a of the ink guide 104 is relatively low, and hence the ink Q that contains the colorant particles concentrated at the tip portion 104a of the ink guide 104 does not fly out from the tip portion 104a of the ink guide 104.

On the other hand, when a pulse voltage of for example 500 V is applied from the pulse voltage source 114 to the control electrode 108 biased at 1.5 kV, a voltage of 2 kV obtained by superposing both the voltages on each other is applied to the control electrode 108. As a result, the ink Q containing the colorant particles which are concentrated at the tip portion 104a of the ink guide 104 flies out in the form of ink droplets R from the tip portion 104a by the electrostatic force, is attracted by the grounded counter electrode 110, and adheres to the recording medium P to form thereon a dot of the colorant particles.

In such a manner, recording is carried out with the dots of the colorant particles while the ink jet head 100 and the recording medium P supported on the counter electrode 110 are relatively moved to thereby record an image corresponding to the image data on the recording medium P.

Such electrostatic ink jetting system is capable of forming fine droplets, and hence is capable of drawing high resolution images. Specially, among the electrostatic ink jetting systems, the electrostatic ink jetting system in which insulating ink obtained by dispersing charged colorant particles in a carrier liquid is used as the ink hardly causes bleeding and is capable of using various recording media for image recording.

### SUMMARY OF THE INVENTION

Although the ink jet recording system disclosed in Patent Document 1 has the superior features described above, the droplet ejection response to the application of a driving voltage is low, which limits the enhancement of a recording frequency. Furthermore, the ejection response to a driving voltage tends to change owing to an ejection history of ink droplets from an ejection portion, so there is a possibility that the ejection of ink droplets may become unstable. Furthermore, the control of ejection/non-ejection of ink droplets is performed at a high driving voltage, which leads to a problem in that an expensive drive is necessary, and hence the control is complicated.

A first object of the present invention is to solve the problems of the conventional technique described above, and to provide an inexpensive fine droplet ejecting device capable of stably ejecting fine droplets at high speed.

A second object of the present invention is to solve the problems of the conventional technique described above, and to provide an inexpensive ink jet recording apparatus capable of drawing an image at high speed with high ejection stability.

In order to achieve the above-mentioned first object, according to a first mode of a first aspect of the present invention, there is provided a fine droplet ejecting device for ejecting fine droplets by applying an electrostatic force to a solution having an electrical charge containing at least fine particles and a medium, said fine droplet ejecting device being characterized by comprising: ejection means having an ejection port, said ejection means for continuously ejecting said fine droplets from said ejection port by applying the electrostatic force to said solution; deflecting means for deflecting said fine droplets ejected from said ejection means based on a control signal; and recovering means for recovering either one of the fine droplets flying straight after being ejected from said ejection means and the fine droplets having a flight direction deflected by said deflecting means.

Herein, in a second mode of the first aspect of the present invention, it is preferable that said ejection means further comprises resolution enhancing means for deflecting said fine droplets in a direction different from said flight direction deflected by said deflecting means.

Furthermore, it is preferable that said resolution enhancing means deflect said fine droplets by applying the electrostatic force to at least one of said solutions and said fine droplets.

Furthermore, it is preferable that said resolution enhancing means deflect said fine droplets in plural directions periodically.

Furthermore, it is preferable that said resolution enhancing means have a first control electrode and a second control electrode placed in parallel around said ejection port, and a control unit for controlling a voltage applied to said first control electrode and said second control electrode.

Furthermore, it is preferable that said ejection means have plural ejection ports.

Furthermore, it is preferable that said fine particles are charged fine particles having an electrical charge.

Furthermore, it is preferable that said fine particles contain an electrical charge and a colorant.

Furthermore, in order to achieve that above-mentioned second object, according to a second aspect of the present invention, there is provided an ink jet recording apparatus using a fine droplet ejecting device according to the first aspect, wherein said solution is ink, the ink jet recording apparatus being characterized in that said deflecting means deflects said fine droplets ejected from said ejection means based on said control signal in accordance with an image signal, thereby landing either one of said fine droplets flying straight after being ejected by said ejection means and said fine droplets having said flight direction deflected by said deflecting means on a recording medium, and said recovering means recovers said fine droplets that is not landed on said recording medium, whereby an image based on said image signal is formed on said recording medium.

Furthermore, it is preferable that said ejection means includes an ejection portion having said ejection port and a counter electrode for forming a predetermined electric field between said counter electrode and said ejection portion, said counter electrode being placed between said ejection portion and said deflecting means.

Furthermore, it is preferable that said counter electrode have an opening on a flight path of said fine droplets.

Furthermore, it is preferable that the ink jet recording apparatus further comprises a back electrode for forming a predetermined electric field between said back electrode and said ejection means, said back electrode being placed at a position opposed to said ejection means across said deflecting means.

Furthermore, it is preferable that said deflecting means is means for applying an electric field or a magnetic field for deflecting the flying fine droplets.

Furthermore, it is preferable that said deflecting means is means for generating an air stream for deflecting the flying fine droplets.

Furthermore, it is preferable that the ink jet recording apparatus further comprises circulation means for supplying said ink to said ejection means and recovering the ink that is not ejected by said ejection means.

Furthermore, it is preferable that the ink jet recording apparatus further comprises recovered ink supply means for supplying said ink recovered by said recovering means to said circulation means.

Furthermore, it is preferable that the ink jet recording apparatus further comprises ink concentration adjusting means for adjusting an ink concentration of said ink.

According to the first aspect of the present invention, a droplet with a minute droplet diameter can be ejected stably at high speed. Furthermore, a droplet can be controlled at a low voltage in accordance with a control signal, which can reduce a cost.

Furthermore, particularly according to the second embodiment in the first aspect, by deflecting a fine droplet in a direction different from a direction in which the deflecting means deflects the fine droplet, the fine droplet can be allowed to fly (ejected) by the ejection means in a plurality of directions, and the fine droplet can be ejected at a density higher than the arrangement density of the ejection ports.

Furthermore, even in providing a plurality of ejection ports, a fine droplet can be ejected at high density without closely arranging adjacent ejection ports.

According to the second aspect of the present invention, an ink droplet with a minute droplet diameter can be ejected stably at high speed, and in the second embodiment, an image with a high resolution and high quality can be drawn at high speed with high drawing stability.

Furthermore, the control of an ink droplet in accordance with an image signal can be performed at a low voltage, which can reduce a cost.

Furthermore, particularly according to the second embodiment in the second aspect, a fine droplet can be controlled at a low voltage in accordance with an image signal, which can reduce a cost. Furthermore, by deflecting a fine droplet in a direction different from a direction in which the deflecting means deflects the fine droplet, the fine droplet can be allowed to fly (ejected) from the ejection means in a plurality of directions, and an image can be recorded at a resolution higher than the arrangement density of the ejection ports. Because of this, even in a case where the arrangement density of the ejection ports is low, an image with a high resolution can be recorded.

Furthermore, by using ink having fine particles containing an electrical charge and a colorant, an ink droplet with fine particles containing a colorant concentrated can be ejected, and an image of high quality can be formed with less blur.

Furthermore, by providing the counter electrode in the ejection means and forming a predetermined electric field between the ejection portion (ejection head) and the counter electrode, an electrostatic force applied to the ejection portion (ejection head) is more stabilized, and a fine droplet (ink droplet) can be ejected more stably. Thus, an image of higher quality with high drawing stability can be drawn at high speed.

Furthermore, by providing the back electrode to form an electric field between the ejection portion (ejection head) and the back electrode, the flight path of a fine droplet (ink droplet) can be controlled with more accuracy.

### BRIEF DESCRIPTION OF THE DRAWINGS

FIG. 1 is a schematic structural view showing one example of an ink jet recording apparatus in one embodiment according to one aspect of a fine droplet ejecting device of the present invention;

FIG. 2A is a partial cross sectional enlarged view of one example of a peripheral portion of an ejection head and a counter electrode of the ink jet recording apparatus shown in FIG. 1, and FIG. 2B is a view taken along the line IIB-IIB in FIG. 2A;

FIG. 3 is an explanatory view schematically showing one example in which multiple ejection ports are arranged on an ejection port substrate of an ejection head with a single line structure of the ink jet recording apparatus shown in FIG. 1;

FIG. 4 is a view taken along the line IV-IV in FIG. 2A schematically showing a planar configuration of a guard electrode of the ejection head with the single line structure shown in FIG. 3;

FIG. 5A is a partial cross sectional perspective view showing a configuration in the vicinity of an ejection portion in the ejection head shown in FIG. 2A, and FIG. 5B is an explanatory view of the shape and dimensions of ink guide dikes of the ejection head shown in FIG. 5A;

FIGS. 6A to 6C are each schematic view illustrating a method of ejecting ink droplets of the ink jet recording apparatus shown in FIG. 1;

FIG. 7 is a schematic structural view showing another example of the ink jet recording apparatus in the one embodiment of the present invention;

FIG. 8 is a schematic structural view showing one example of the ink jet recording apparatus in another embodiment according to one aspect of the fine droplet ejecting device of the present invention;

FIG. 9A is a schematic cross sectional view showing a schematic configuration of an ejection head and a counter electrode peripheral portion of ejection means of the ink jet recording apparatus shown in FIG. 8, and FIG. 9B is a cross sectional view taken along the line B-B in FIG. 9A;

FIG. 10 is a cross sectional view taken along the line X-X in FIG. 9B, schematically showing one example in which multiple ejection ports are arranged on an ejection port substrate of an ejection head with a single line structure of the ink jet recording apparatus shown in FIG. 8;

FIG. 11 is a cross sectional view taken along the line XI-XI shown in FIG. 9B, schematically showing a planar configuration of a first control electrode and a second control electrode of the ejection head with a single line structure shown in FIG. 10;

FIG. 12 is a partial cross sectional perspective view showing a configuration in the vicinity of an ejection portion in the ejection head in FIG. 9A,

FIGS. 13A to 13C are each schematic view illustrating a method of ejecting ink droplets of the ink jet recording apparatus shown in FIG. 8;

FIG. 14 shows a voltage waveform of a voltage applied to the first control electrode of the ejection head shown in FIG. 9B and an ejection timing of an ink droplet;

FIG. 15 is an explanatory view schematically showing flight paths of ink droplets from an ejection head to a recording medium or a gutter in the ink jet recording apparatus shown in FIG. 8;

FIG. 16 is a schematic structural view showing another example of the ink jet recording apparatus in the another embodiment of the present invention; and

FIG. 17 is a schematic view showing one example of an ink jet head of a conventional ink jet recording apparatus.

### DETAILED DESCRIPTION OF THE PREFERRED EMBODIMENTS

Hereinafter, a fine droplet ejecting device according to the first aspect of the present invention and an ink jet recording apparatus according to the second aspect of the present invention will be described in detail by way of preferable embodiments shown in the attached drawings.

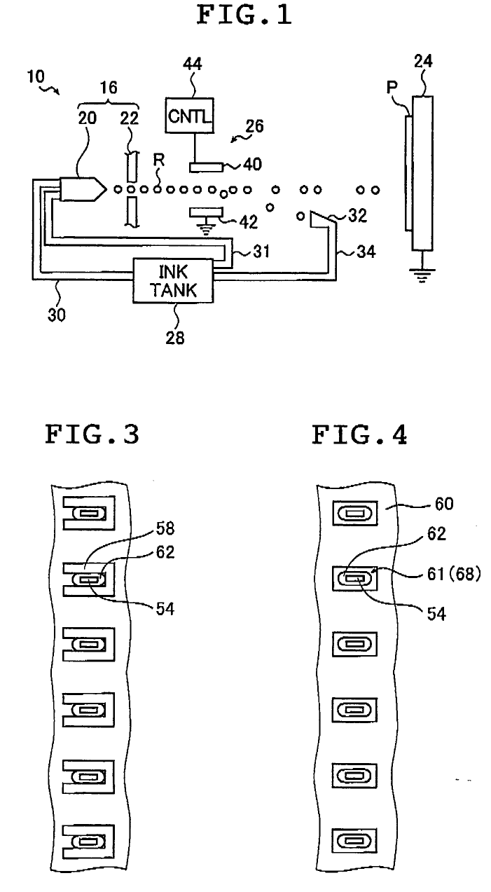

First, referring to FIGS. 1 to 7, the fine droplet ejecting device of a first embodiment according to the first aspect of the present invention and the ink jet recording apparatus of the first embodiment according to the second aspect of the present invention will be described.

FIG. 1 is a schematic structural view showing one example of an ink jet recording apparatus of the first embodiment according to the second aspect of the present invention in which a fine droplet ejecting device of the first embodiment according to the first aspect of the present invention is used.

As shown in FIG. 1, an ink jet recording apparatus 10 comprises an ejection head (ink jet head) 20 having ejection ports for ejecting fine droplets, a counter electrode 22 for forming a predetermined electric field between the counter electrode 22 and the ejection head 20, a back electrode 24 for holding a recording medium P, deflecting means-26 for deflecting the fine droplets ejected from the ejection head 20, an ink tank 28 and an ink supply flow path 30 though which ink is supplied to the ejection head 20, and a gutter 32 and a first ink recovery flow path 34 for recovering the fine droplets deflected by the deflecting means 26 in the ink tank 28. Herein, the ejection head 20 and the counter electrode 22 constitute ejection means 16 of the present invention.

Herein, multiple first deflection electrodes 40 and second deflection electrodes 42 are arranged so as to correspond to the ejection portions provided for the ejection head 20. For ease of understanding on a configuration, FIG. 1 merely shows one of the first deflection electrodes 40, one of the second deflection electrodes 42, and one gutter 32.

Next, the ejection means 16 will be described in detail.

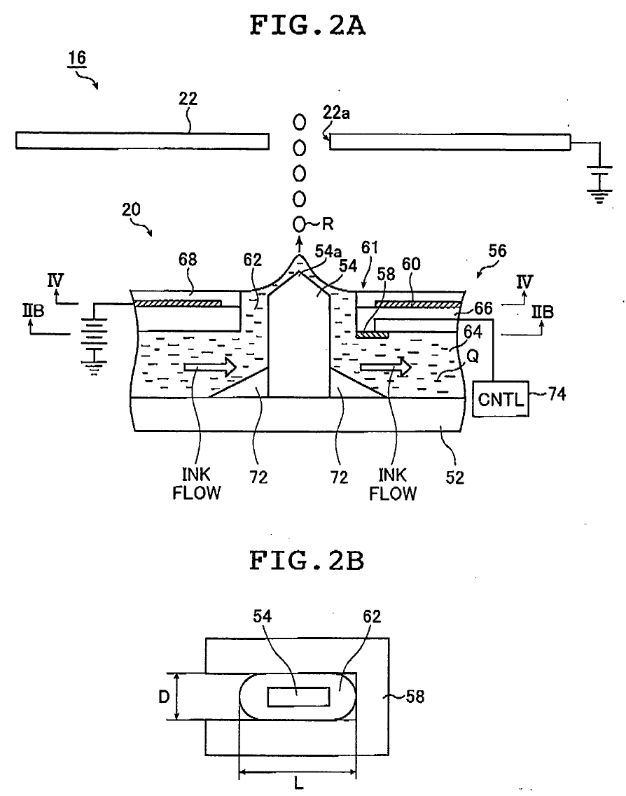

FIG. 2A shows a partial cross sectional enlarged view of one example of a peripheral portion of the ejection head 20 and the counter electrode 22 constituting the ejection means 16 of the ink jet recording apparatus 10 shown in FIG. 1. FIG. 2B shows a view taken along the line IIB-IIB in FIG. 2A for illustrating an ink guide 54, an ejection port 62, and an ejection electrode 58 of the ejection head 20 in FIG. 2A.

As described above, the ejection means 16 comprises the ejection head 20 and the counter electrode 22 placed at a position opposed to the surface of the ejection head 20 on an ink ejection side.

The ejection head 20 forms an electric field of a predetermined intensity between the ejection head 20 and the counter electrode 22, and continuously ejects an ink droplet with a minute droplet diameter. The ejection head 20 comprises a head substrate 52, the ink guides 54, and an ejection port substrate 56 in which the ejection ports 62 are formed. On the ejection port substrate 56, the ejection electrodes 58 are placed so as to surround the respective ejection ports 62.

Furthermore, the head substrate 52 and the ejection port substrate 56 are placed at a predetermined interval while being opposed to each other. The space formed between the head substrate 52 and the ejection port substrate 56 forms an ink flow path 64 through which ink is supplied to each ejection port 62.

The ejection head 20 has a single line structure in which multiple ejection ports (nozzles) 62 are arranged in a single line so as to record an image at high speed. FIG. 3 schematically shows a state in which the multiple ejection ports 62 are arranged in a single line on the ejection port substrate 56 of the ejection head 20 having such a single line structure. In FIGS. 2A and 2B, for ease of understanding on a configuration of the ink jet head, only one of the multiple ejection ports is shown.

In the ejection head 20 according to this embodiment, the number of ejection ports 62, the physical arrangement position thereof and the like can be selected freely. For example, the ejection head 20 may have a multi-line structure instead of the single line structure shown in FIG. 3. The ejection head 20 may also be a so-called serial head (shuttle type) which performs scanning in a direction orthogonal to a nozzle line direction.

The ink jet head of the present invention also is applicable to a monochromatic or color recording device.

In such ejection head 20, ink Q is used in which fine particles (hereinafter referred to as the “colorant particles”) containing colorant such as pigment are dispersed in an insulative liquid (carrier liquid). Also, an electric field is generated at the ejection port 62 through application of a bias voltage (drive voltage) to the ejection electrode (control electrode) 58 provided for the ejection port substrate 56 and the ink at the ejection port 62 is ejected by means of an electrostatic force.

The configuration of the ejection head 20 of this embodiment shown in FIGS. 2A and 2B will be described in more detail below.

As shown in FIG. 2A, the ejection port substrate 56 of the ejection head 20 comprises an insulating substrate 66, a guard electrode 60, the ejection electrode 58, and an insulating layer 68. On a surface of the insulating substrate 66 on an upper side in FIG. 2A (surface opposite to a side facing the head substrate 52), the guard electrode 60 and the insulating layer 68 are laminated in order. Also, on a surface of the insulating substrate 66 on a lower side in FIG. 2A (surface on the side facing the head substrate 52), the ejection electrode 58 is formed.

Also, in the ejection port substrate 56, the ejection port 62 for ejecting ink droplets R is formed so that it passes through the insulating substrate 66. As shown in FIG. 2B, the ejection port 62 is a cocoon-shaped opening (slit) elongated in the ink flow direction, which is formed by forming both short sides of a rectangle into a semicircular shape. More specifically, the ejection port 62 has a shape in which an aspect ratio (L/D) between a length L in the ink flow direction and a length D in the direction orthogonal to the ink flow is 1 or more.

In this embodiment, by setting the ejection port 62 as such an opening whose aspect ratio (L/D) between the length L in the ink flow direction and the length D in the direction orthogonal to the ink flow is 1 or more (a shape having shape anisotropy with its long sides extending in the ink flow direction, or a long hole with its long sides extending in the ink flow direction), the ink becomes easy to flow to the ejection port 62. That is, supplying property of the ink to the ejection port 62 is enhanced, which makes it possible to improve frequency response and also prevent clogging.

That is, in the present invention, as shown in FIG. 2B, it is preferable that the ejection ports 62 be formed so that the longitudinal direction of the elongated cocoon-shaped slit is parallel to the ink flow direction. Thus, even in the case of the ejection head 20 having a single line structure shown in FIG. 3, each ejection port 62 is preferably formed so that the longitudinal direction of the elongated cocoon-shaped slit is parallel to the ink flow direction. Therefore, it is preferable that the ejection head 20 be formed so that the ejection ports 62 are arranged in a line in a direction orthogonal to the ink flow direction. Note that in the case of the ejection head 20 having the single line structure, preferably, the conveying direction of the recording medium be parallel to the ink flow direction.

In this embodiment, the ejection port 62 is formed as the elongated cocoon-shaped opening, however, the present invention is not limited to this and it is possible to form the ejection port 62 in another arbitrary shape, such as an approximately circular shape, an oval shape, a rectangular shape, a rhomboid shape, and a parallelogram shape, so long as it is possible to eject the ink from the ejection port 62. For instance, the ejection port may be formed in a rectangular shape whose long sides extend in the ink flow direction, or an oval shape or a rhomboid shape whose long axis extends in the ink flow direction. Also, the ejection port may be formed in a trapezoidal shape with its upper base being on the upstream side of the ink flow, its lower base being on the downstream side, and its height in the ink flow direction being set longer than the lower base. In this case, it does not matter whether the side on the upstream side is longer than the side on the downstream side or the side on the downstream side is longer than the side on the upstream side. Also, the ejection port 62 may be formed so as to be symmetric or asymmetric with respect to the center thereof on both of the upstream side and the downstream side. For example, at least one of end portions of the upstream side and the downstream side of the rectangular ejection port with respect to the center may be formed into a semicircular shape.

The ink guide 54 of the ejection head 20 is produced from a ceramic-made flat plate or a flat plate made of resin such as polyimide with a predetermined thickness, and is disposed on the head substrate 52 for each ejection port 62 (ejection portion). The ink guide 54 is formed so that it has a somewhat wide width in accordance with the length of the cocoon-shaped ejection port 62 in a long-side direction. As described above, the ink guide 54 passes through the ejection port 62 and its tip end portion 54a protrudes upwardly from a surface of the ejection port substrate 56 on the recording medium P side (surface of the insulating layer 68).

The tip end portion 54a of the ink guide 54 is formed so that it has an approximately triangular shape (or a trapezoidal shape) that is gradually narrowed as a distance to the counter electrode 22 side is reduced. The ink guide 54 is disposed so that a surface of the tip end portion 54a is inclined in the ink flow direction. With this configuration, the ink flowing into the ejection port 62 moves along the inclined surface of the tip end portion 54a of the ink guide 54 and reaches the vertex of the tip end portion 54a, so a meniscus of the ink is formed at the ejection port 62 with stability.

Also, by forming the ink guide 54 so that it is wide in the long-side direction of the ejection port 62, it becomes possible to reduce a width in the direction orthogonal to the ink flow and reduce influence on the ink flow, which makes it possible to form the meniscus to be described later with stability.

It should be noted here that the shape of the ink guide 54 is not specifically limited. For instance, it is possible to change the shape of the ink guide 54 as appropriate to a shape other than the shape in which the tip end portion 54a is gradually narrowed toward the counter electrode 22 side. For instance, a slit serving as an ink guide groove that gathers the ink Q to the tip end portion 54a by means of a capillary phenomenon may be formed in a center portion of the ink guide 54 in a vertical direction in FIG. 2A.

Also, it is preferable that a metal be evaporated onto the extreme tip end portion of the ink guide 54 because the dielectric constant of the tip end portion 54a of the ink guide 54 is substantially increased through the evaporation of the metal onto the extreme tip end portion of the ink guide 54. As a result, a strong electric field is generated at the ink guide 54 with ease, which makes it possible to improve ejection property of the ink.

As shown in FIGS. 2A and 2B, for the lower surface (surface facing the head substrate 52) of the insulating substrate 66, the ejection electrode 58 is formed. The ejection electrode 58 has a reversed C-letter shape in which one side on the upstream side in the ink flow direction is removed, and is disposed along the rim of the rectangular shaped ejection port 62 so as to surround the periphery of the ejection port 62. Since the ejection electrode 62 is formed into a reversed C-letter shape in which a part on the upstream side in the ink flow direction is removed, in the case of using ink containing charged colorant particles to be described later, electric field which prevents colorant particles from flowing into an ejection port from the upstream side in the ink flow direction is not formed, whereby the colorant particles can be effectively supplied to the ejection port. Moreover, since a part of the ejection electrode 58 is disposed on the downstream side of the ejection port 62 in the ink flow direction, electric field is formed in the direction so that colorant particles flowed into an ejection port is kept at the ejection port. Accordingly, by forming an ejection electrode into a reversed C-letter shape in which a part on the upstream side in the ink flow direction is removed, it is also possible to enhance the particle supplying property to an ejection port.

In this embodiment, the ejection electrode 58 is formed in a reversed C-letter shape in view of obtaining the above effects, however, it is possible to change the ejection electrode 58 to various other shapes so long as the ejection electrode is disposed to face an ink guide. For example, the ejection electrode 58 may be a ring shaped circular electrode, an oval electrode, a divided circular electrode, a parallel electrode or a substantially parallel electrode, corresponding to the shape of the ejection port 62.

As described above, the ejection head 20 has a configuration in which multiple ejection ports 62 are arranged. Therefore, as schematically shown in FIG. 3, the ejection electrodes 58 are respectively disposed for the ejection ports 62.

Also, the ejection electrodes 58 are exposed to the ink flow path 64 and contact the ink Q flowing in the ink flow path 64. Thus, it becomes possible to significantly improve ejection property of ink droplets. This point will be described in detail later together with an action of ejection. Here, the ejection electrode 58 is not necessarily required to be exposed to the ink flow path 64 and contact the ink. For instance, the ejection electrode 58 may be formed in the ejection port substrate 56 or a surface of the ejection electrode 58 exposed to the ink flow path 64 may be covered with a thin insulating layer.

As shown in FIG. 2A, the ejection electrode 58 is connected to a control unit (CNTL) 74 which is capable of controlling the voltage applied to the ejection electrode 58 at the time of ejection and non-ejection of the ink droplets.

The guard electrode 60 is formed on a surface of the insulating substrate 66, and a surface of the guard electrode 60 is covered with the insulating layer 68. In FIG. 4, a planar configuration of the guard electrode 60 is schematically shown. FIG. 4 is a view taken along the line IV-IV in FIG. 2A and schematically shows the planar configuration of the guard electrode 60 of the ink jet head (ejection head 20) having a single line structure shown in FIG. 3. As shown in FIG. 4, the guard electrode 60 is a sheet-shaped electrode, such as a metallic plate, which is common to each ejection electrode and has openings 61 at positions corresponding to the ejection electrodes 58 respectively formed on the peripheries of the ejection ports 62 arranged in a two-dimensional manner. Each opening 61 is formed in a rectangular shape. The opening 61 of the guard electrode 60 is formed so that it has a length and a width exceeding the length and the width of the ejection port 62.

It is possible for the guard electrode 60 to suppress electric field interference by blocking electric lines of force between adjacent ejection electrodes 58, and a predetermined voltage (including 0 v when grounded) is preferably applied to the guard electrode 60. In the illustrated embodiment, a voltage lower than that applied to the ejection electrode 58 by a predetermined voltage (300V) is applied to the guard electrode 60 (for example, the voltage of 2.7 kV is applied to the guard electrode when the voltage of +3 kV is applied to the ejection electrode). Here, the voltage applied to the guard electrode 60 may be adjusted as appropriate.

As a preferred embodiment, as shown in FIG. 2A, the guard electrode 60 is formed in the layer different from that containing the ejection electrodes 58, and moreover, its whole surface is covered with the insulating layer 68.

The ejection head 20 has the insulating layer 68, whereby strong electric field can be formed between the ejection electrode 58 and the guard electrode 60, and also the colorant particles of the ink Q can be prevented from being covered to cause discharging between the ejection electrode 58 and the guard electrode 60.

Here, the guard electrode 60 needs to be provided so as to ensure the electric lines of force acting on the corresponding ejection port 62 (hereinafter referred to as “own channel” for convenience) among the electric lines of force generated from the ejection electrodes 58.

If the above points are taken into consideration, the width and the length of the rectangular opening 61 of the guard electrode 60, when the substrate plane is viewed from above, is preferably made larger than the width and the length of the ejection electrode 58 of the own channel to avoid blocking the electric lines of force directed to the own channel. Specifically, the end portion of the guard electrode 60 on the ejection port 62 side is preferably more spaced apart (retracted) from the ejection port 62 than the inner edge portion of the ejection electrode 58 of the own channel.

In addition, for efficiently forming the ejection electric field between the ejection electrodes 58, the length and the width of the rectangular opening 61 of the guard electrode 60, when the substrate plane is viewed from above, is preferably made smaller than the spacing between the outer edge portions of the ejection electrode 58 of the own channel. Specifically, the inner edge portion of the guard electrode 60 is preferably closer (advanced) to the ejection port 62 than the outer edge portion of the ejection electrode 58 of the own channel. According to the studies made by the inventor of the present invention, the distance between the outer edge portion of the ejection electrode 58 and the inner edge portion of the guard electrode 60 is preferably equal to or larger than 5 μm, more preferably equal to or larger than 10 μm.

The guard electrode 60 may be provided (that is, the opening 61 of the guard electrode 60 may be formed) so that the shape of the opening 61 of the guard electrode 60 is made substantially similar to the shape formed by the inner edge portion or the outer edge portion of the ejection electrode 58, and the inner edge portion of the guard electrode 60 is more spaced apart (retracted) from the ejection port 62 than the inner edge portion of the ejection electrode 58 of the own channel and is closer (advanced) to the ejection port 62 than the outer edge portion of the ejection electrode 58.

Also, in the above example, the guard electrode 60 is made as a sheet-shaped electrode, however, this embodiment is not limited to this and the guard electrode 60 may have any other shapes or structures. For instance, the guard electrode 60 may be provided between respective ejection ports in a mesh shape.

Here, the shape of the opening 61 of the guard electrode 60 is set approximately the same as the shape of the ejection port 62, however, the present invention is not limited to this and the opening 61 of the guard electrode 60 may have another arbitrary shape. For instance, it is possible to form the opening 61 in a circular shape, an oval shape, a square shape, or a rhomboid shape.

Preferably, the guard electrode is provided in view of obtaining the above effects, however, the guard electrode is not an indispensable component. Therefore, the guard electrode may not be provided.

In the ejection head 20 in this embodiment, as a preferable form, ink guide dikes 72 that induce the ink to the ejection port 62 are provided on the head substrate 52.

The ink guide dikes 72 will be described in detail below.

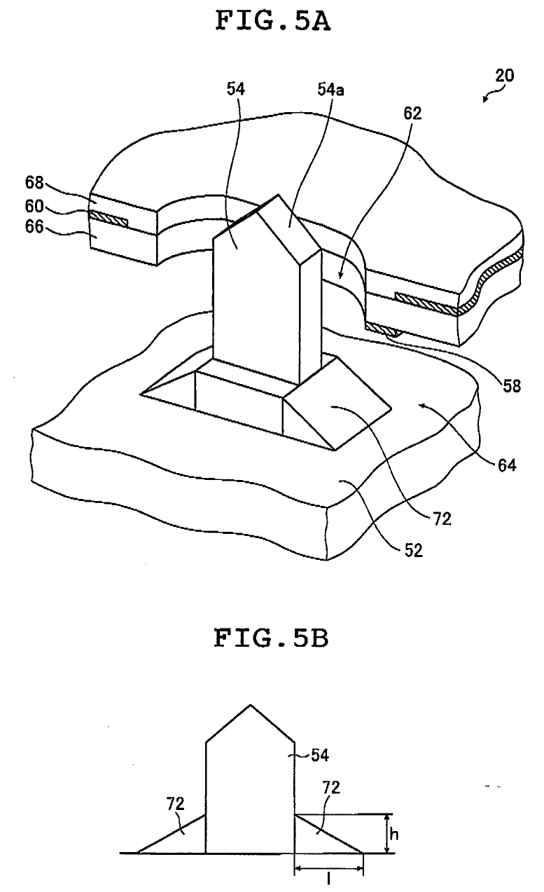

FIG. 5A is a partial cross sectional perspective view showing a configuration in the vicinity of the ejection portion in the ejection head 20 shown in FIG. 2A. In FIG. 5A, in order to demonstrate clearly the configuration of the ink guide dike 72, the ejection port substrate 56 is shown under the condition of being cut along the ink flow direction at a nearly central position of the ink guide 54.

The ink guide dikes 72 are disposed on a surface of the head substrate 52 on the ink flow path 64 side, i.e., on a bottom surface of the ink flow path 64, and respectively provided on upstream and downstream sides of the ink guide 54 disposed at a position corresponding to the ejection port 62 in the ink flow direction. Also, each ink guide dike 72 has a surface which inclines so as to become gradually closer to the ejection port substrate 56 from the vicinity of the position corresponding to the ejection port 62 toward the position corresponding to the center of the ejection port 62 with respect to the ink flow direction. That is, each ink guide dike 72 has such a shape as to incline toward the ejection port 62 along the ink flow direction.

In addition, each ink guide dike 72 is constructed so as to have nearly the same width as that of the ejection port 62 in a direction intersecting perpendicularly the ink flow direction, and have a side wall which is erected from the bottom face. In addition, the ink guide dikes 72 are provided at a predetermined distance from the surface of the ejection port substrate 56 on the ink flow path 64 side, i.e., from the upper surface of the ink flow path 64 so as to ensure the flow path of the ink Q without blocking up the ejection port 62. Such ink guide dikes 72 are provided for the respective ejection portions.

The ink guide dikes 72 inclining toward the ejection port 62 are provided on the bottom surface of the ink flow path 64 along the ink flow direction, whereby the ink flow directed to the ejection port 62 is formed and hence the ink Q is guided to the opening portion of the ejection port 62 on the side of the ink flow path 64. Thus, it is possible to suitably make the ink Q to flow to the inside of the ejection port 62, and it is also possible to enhance the supplying property of the ink Q. Further, it is possible to more surely prevent the ejection port 62 from being clogged.

The length 1 of the ink guide dike 72 in the ink flow direction has to be appropriately set so as to suitably guide the ink Q to the ejection port 62 within a range of not interfering with any of the adjacent ejection ports. Thus, as shown in FIG. 5B, the length 1 of the ink guide dike 72 is preferably 0.5 or more times as large as the height h of a highest portion of the ink guide dike 72 (1/h≧0.5), and is more preferably 1 or more times as large as the height h of the highest portion of the ink guide dike 72 (1/h≧1).

The width of the ink guide dike 72 in the direction intersecting perpendicularly the ink flow direction is preferably equal to that of the ejection port 62 or slightly wider than that of the ejection port 62. In addition, the ink guide dike 72 is not limited to the illustrated example having a uniform width. Thus, there may also be adopted an ink guide dike having a gradually decreasing width, an ink guide dike having a gradually increasing width, or the like. In addition, each side wall of the ink guide dike 72 is not limited to the vertical plane, and hence may also be an inclined plane or the like.

An inclined plane (ink guide surface) of the ink guide dike 72 need only have a shape which is suitable for guiding the ink Q to the ejection port 62. Thus, a slope having a fixed angle of inclination may be adopted for the inclined plane of the ink guide dike 72. Or, a surface having a changing angle of inclination, or a curved surface may also be adopted for the inclined plane of the ink guide dike 72. In addition, the surface of the inclined plane of the ink guide dike 72 is not limited to a smooth surface. Thus, one or more ridges, grooves or the like may be formed along the ink flow direction, or radially toward the central portion of the ejection port 62 on the inclined plane of the ink guide dike 72.

In addition, the upper portion of the ink guide dike 72 and the ink guide 54 may also be smoothly connected to each other without creating a step in the vicinity of a connection portion between the upper portion of the ink guide dike 72 and the ink guide 54 as in the illustrated example.

In the illustrated example, there is adopted a form in which the ink guide dikes 72 are disposed on the upstream and downstream sides of the ink guide 54, respectively. However, alternatively, there may also be adopted a form in which a trapezoidal ink guide dike 72 having slopes on the upstream and downstream sides of the ejection port 62, respectively, is provided, and the ink guide 54 is erected on the upper portion of this trapezoidal ink guide dike 72. Or, the ink guide 54 and the ink guide dike 72 may also be formed integrally with each other. As described above, the ink guide dike 72 may be formed separately from or integrally with the ink guide 54 to be mounted to the head substrate 52, or may also be formed by digging the head substrate 52 using the conventionally known digging means.

It should be noted that while the ink guide dike 72 has to be provided on the upstream side of the ejection port 62, as in the illustrated example, the ink guide dike 72 is preferably provided on the downstream side as well of the ejection port 62 so that its height in the direction of ejection of the ink droplet R becomes lower with increasing a distance from the ejection port 62. As a result, the ink Q which has been guided toward the ejection port 62 by the ink guide dike 72 on the upstream side smoothly flows into the downstream side. Hence, the stability of ink flow can be maintained without a turbulent flow of the ink Q, enabling to maintain ejection stability.

In the example shown in FIG. 5A, the ink guide dikes 72 are disposed on the upper surface of the head substrate 52. However, the present invention is not limited to this and there may also be adopted a structure in which an ink flow groove is provided in the head substrate 52, and the ink guide dikes are disposed inside the ink flow groove.

For example, the ink flow groove having a predetermined depth is provided so as to extend through a position corresponding to the ejection port 62 along the ink flow direction. Further, there are provided ink guide dikes having the surfaces inclining toward the ejection port 62 along the ink flow direction in the position corresponding to the ejection port 62. In such a manner, the provision of the ink flow groove can make most of the ink Q flowing through the ink flow path 64 selectively flow in the ink flow groove, and the provision of the ink guide dikes can make the ink Q suitably flow to the inside of the ejection port 62. Hence, it is possible to enhance the supplying property of the ink to the tip portion 54a of the ink guide 54.

As shown in FIG. 2A, the counter electrode 22 is disposed so as to be opposed to the ejection surface of the ink droplets of the ejection head 20.

The counter electrode 22 is disposed at a position facing the tip portion 54a of the ink guide 54, and a predetermined voltage is applied thereto. An opening 22a is formed in the counter electrode 22 on the flight path of ink droplets. In this embodiment, the opening 22a is formed to have a predetermined diameter with a contact point of a vertical line extending from the tip portion 54a of the ink guide 54 with the counter electrode 22 as a center.

In the electrostatic ink jet recording head of the present embodiment in which the ink Q containing charged colorant particles as described above is used, there is not adopted the process in which a force is caused to act on the overall ink to fly the ink towards the recording medium as in a conventional ink jet system, but there is adopted the process in which a force is caused to mainly act on the colorant particles as the solid components dispersed into the carrier liquid to fly the ink.

The ejection action of ink droplets R from the ejection head 20 will be described below.

As shown in FIG. 2A, in the ejection head 20, the ink Q, which contains colorant particles charged with the same polarity (for example, charged positively) as that of a voltage applied to the ejection electrode 58 at a time of ejection of ink droplets, is supplied from the ink supply flow path 30 (see FIG. 1) described later, and circulates in an arrow direction (from left to right in FIG. 2A) in the ink flow path 64.

On the other hand, upon recording, as described above, a voltage with the same polarity as that of the colorant particles, i.e., a predetermined positive voltage (+500 V as an example) is applied to the counter electrode 22 from the voltage source.

Under the above condition, at a time of ejection of ink droplets, the control unit 74 performs control so that a predetermined voltage (hereinafter, referred to as a bias voltage; +3 kV as an example) is further applied to the ejection electrode 58.

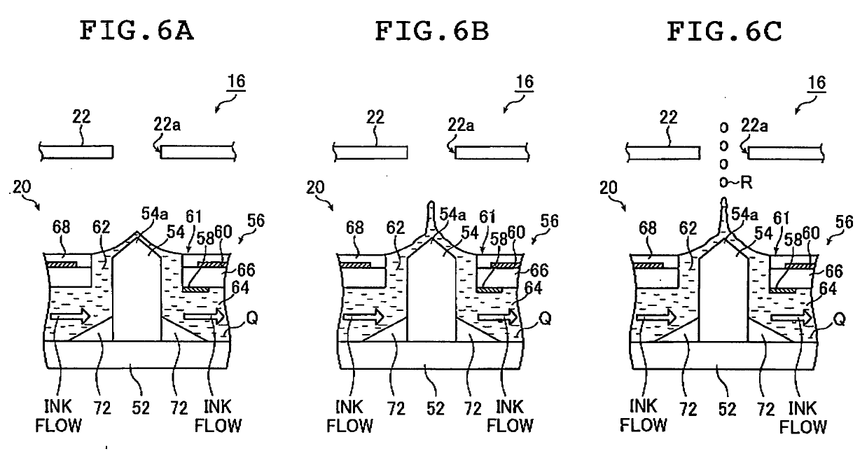

Immediately after the application of the bias voltage, Coulomb attraction acting between the differential voltage (potential difference) between the bias voltage applied to the ejection electrode 58 and the voltage applied to the counter electrode 22 and the charges of the colorant particles of the ink Q, Coulomb repulsion among the colorant particles, viscosity, surface tension and dielectric polarization force of the carrier liquid, and the like act on the ink Q, and these forces operate in conjunction with one another to move the colorant particles and the carrier liquid. Thus, as conceptually shown in FIG. 6A, a meniscus shape in which the ink Q slightly rises from the ejection port 62 is formed.

Furthermore, the Coulomb attraction and the like allow the colorant particles to move toward the counter electrode 22 at a potential lower than that of the ejection electrode 58 through a so-called electrophoresis process owing to the potential difference between the ejection electrode 58 and the counter electrode 22. Therefore, the ink Q is concentrated at the meniscus formed in the ejection port 62.

When a finite period of time further elapses after the start of the application of the bias voltage to the ejection electrode 58, the balance mainly between the force acting on the colorant particles (Coulomb force and the like) and the surface tension of the carrier liquid is broken at the tip portion of the meniscus having the high electric field strength due to the movement of the colorant particles or the like. As a result, the meniscus abruptly grows to form a slender ink liquid column called the thread having about several μm to several tens of μm in diameter as conceptually shown in FIG. 6B.

When a finite period of time further elapses, the thread grows, and is divided due to the interaction resulting from the growth of the thread, the vibrations generated due to the Rayleigh/Weber instability, the ununiformity in distribution of the colorant particles within the meniscus, the ununiformity in distribution of the electrostatic field applied to the meniscus, and the like. As shown in FIG. 6C, the divided thread is then ejected and flown in the form of the ink droplet R toward the counter electrode 22 to pass through the opening 22a formed in the counter electrode 22. The growth of the thread and its division, and moreover the movement of the colorant particles to the meniscus (thread) are continuously generated while the bias voltage is applied to the ejection electrode.

Herein, the ink droplets R ejected immediately after the application of the bias voltage (immediately after the start of the division of the thread) are ejected under such a condition that concentration of the colorant particles, droplet diameter, and division frequency are unstable, so the ink droplets R become nonuniform. Then, after a lapse of predetermined time from the application of the bias voltage, the amount of the ink Q supplied to the ejection port 62 and the amount of the ink 0 divided and ejected become equilibrium state, therefore, during the application of the bias voltage, the fine ink droplets R with a constant concentration of the colorant particles and uniform droplet diameter are ejected at a constant division frequency.

Thus, in the electrostatic ink jet head, through an application of an electrostatic force to the ejection port 62, ink droplets having a diameter smaller than the opening diameter of the ejection port 62 can be ejected stably. Because of this, compared with a piezoelectric or thermal ink jet head for ejecting ink droplets having a diameter larger than that of the opening diameter of the ejection port, the electrostatic ink jet head can eject the ink droplets R having a very small droplet diameter.

Furthermore, in this embodiment, although the application of a DC voltage as the bias voltage has been exemplified, a DC voltage with a pulse-shaped voltage superimposed thereon may be used as the bias voltage, and an AC voltage may also be used. Furthermore, perturbation may be applied through an ultrasonic wave, an electrostatic force, heat or the like so as to stabilize the division of the thread.

Returning to FIG. 1, description of the ink jet recording apparatus 10 will be continued.

As shown in FIG. 1, the back electrode 24 is placed in parallel with the counter electrode 22 at a position opposed to the ejection head 20 across the counter electrode 22, and is electrically grounded.

The recording medium P is held on the surface of the back electrode 24 on the left side in FIG. 1, i.e., on the surface of the back electrode 24 on the ejection head 20 side, and the back electrode 24 functions as a platen of the recording medium P. Furthermore, in the present embodiment, it is preferable that the back electrode 24 comprise conveying means (not shown) so as to convey the recording medium P in a predetermined direction.

Herein, the back electrode 24 is grounded, and a predetermined positive voltage (+500 V) is applied to the counter electrode 22, whereby a predetermined electric field is formed between the counter electrode 22 and the back electrode 24. On the other hand, a bias voltage is applied to the ejection electrode 58, whereby a predetermined electric field for ejecting the ink droplets R is formed between the ejection electrode 58 and the counter electrode 22.

The ink droplet R that was ejected from the ejection head 20 by the action of the electric field formed between the ejection electrode 58 and the counter electrode 22 and passed through the opening 22a of the counter electrode 22 is attracted to the back electrode 24 side, i.e., the recording medium P side by the action of the electric field formed between the counter electrode 22 and the back electrode 24, and flies straight toward the back electrode 24.

The deflecting means 26 comprises the first deflection electrode 40, the second deflection electrode 42, and the control unit (CNTL) 44 placed via the flight paths of the ink droplets R between the counter electrode 22 and the back electrode 24.

The first deflection electrode 40 is connected to the control unit 44, and the second deflection electrode 42 is electrically grounded.

The control unit 44 controls a voltage applied to the first deflection electrode 40 in accordance with an image signal, and forms an electric field between the first deflection electrode 40 and the second deflection electrode 42. Herein, a voltage having the same polarity as that of the ink droplets R is applied from the control unit 44 to the first deflection electrode 40 in accordance with an image signal.

The ink droplet R ejected from the ejection head 20 passes through the opening 22a formed on the flight path of the ink droplet of the counter electrode 22. After this, the ink droplet R flies straight toward the back electrode 24 to pass between the first deflection electrode 40 and the second deflection electrode 42. Herein, the ink droplet R passing between the first deflection electrode 40 and the second deflection electrode 42 under the application of a voltage from the control unit 44 receives a force acting in a direction from the first deflection electrode 40 to the second deflection electrode 42 by the action of the electric field formed between the first deflection electrode 40 and the second deflection electrode 42, and the flight path is deflected at a predetermined angle to the second deflection electrode 42 side. Furthermore, the ink droplet R passing between the first deflection electrode 40 and the second deflection electrode 42 in the absence of a voltage flies straight to the back electrode 24 side without having its flight path deflected, and lands on the recording medium P.

There is no particular limit to the voltage applied to the first deflection electrode 40 and the second deflection electrode 42. For example, ink droplets may be deflected by the action of an electric field formed by grounding the first deflection electrode 40 and applying a voltage having a polarity different from that of the ink droplets to the second deflection electrode 42.

The gutter 32 is used for recovering ink droplets that have its flight paths deflected by the deflecting means 26, and is placed at a position shifted by a predetermined distance from the flight path of an ink droplet flying straight toward the back electrode 24 to the second deflection electrode 42 side, between the deflecting means 26 and the back electrode 24.

The ink droplets having its flight paths deflected by the deflecting means 26 land on the gutter 32, and are recovered in the ink tank 28 from the gutter 32 via the first ink recovery flow path 34.

The ink tank 28 stores ink. The ink tank 28 is connected to the ejection head 20 via the ink supply flow path 30 and the second ink recovery flow path 31, and is connected to the gutter 32 via the first ink recovery flow path 34.

The ink tank 28 supplies a predetermined amount of ink to the ejection head 20 with a pump (not shown) via the ink supply flow path 30, and recovers ink that has not been used for ejection at the ejection head 20 via the second ink recovery flow path 31. Thus, a predetermined amount of ink circulates between the ejection head 20 and the ink tank 28. Furthermore, the ink droplets having landed on the gutter 32 are recovered in the ink tank 28 via the first ink recovery flow path 34.

Herein, it is preferable that the ink tank 28 have an ink concentration adjusting mechanism for adjusting the concentration of ink, and adjust as needed the concentration of ink circulating between the ejection head 20 and the ink tank 28 and the concentration of ink stored in the ink tank 28, thereby supplying ink with a predetermined concentration to the ejection head 20 at all times.

Furthermore, it is preferable that a filter for removing impurities and ink enlarged by being solidified be provided in at least one of the ink tank 28, the ink supply flow path 30, the second ink recovery flow path 31, and the first ink recovery flow path 34.

As described above, the ink jet recording apparatus of the present invention is a continuous ink jet recording apparatus, in which an ink droplet is ejected continuously through an application of an electrostatic force to the ejection head, and the ink droplets are deflected selectively by the deflecting means in accordance with an image signal to control the ink droplets to be landed on a recording medium, thereby forming an image.

Thus, according to the electrostatic and continuous ink jet recording apparatus, recording can be performed under the condition that ink droplets are always ejected from the ejection head, which enhances the response to an image signal and increases a recording frequency.

Furthermore, the thread is divided at a very high frequency. Therefore, the ejection frequency of ink droplets becomes high, and consequently, high-speed drawing can be performed. As an example, in the ink jet head of the present embodiment, ink droplets can be ejected at least at an ejection frequency of about 200 kHz.

Furthermore, by applying an electrostatic force to the ejection port to allow ink droplets to be ejected, it is possible to eject ink droplets with a diameter smaller than that of the ejection port, which makes it possible to form an image with a high resolution. As an example, in the ink jet head of the present embodiment, ink droplets with a droplet diameter of about 0.05 pl to 2 pl can be ejected.

Furthermore, in the ink jet recording apparatus of the present embodiment, ink droplets can be deflected by applying a low voltage to the deflection electrode. Because of this, compared with an on-demand type ink jet recording apparatus that performs recording of an image through control of ejection/non-ejection of ink droplets with a voltage applied to the ejection electrode, the control can be performed in accordance with an image signal at a low voltage, and a control device can be made inexpensive. Furthermore, power consumption can be reduced.

Furthermore, since ink droplets to be ejected have electrical charges, it is not necessary to charge ink droplets by charging means, and the ink droplets can be deflected by deflecting means, which can simplify the configuration of the apparatus.

Furthermore, ink droplets are ejected at all times during recording of an image irrespective of an image signal. Therefore, the aggregation of ink at the ejection port and the clogging of the ejection port, which occur when ink droplets are not ejected for a long period of time, can be prevented. This can prevent the breakdown of the ejection head, and simplifies maintenance.

Furthermore, during recording of an image, an image is formed with ink droplets ejected under the condition that the concentration of the colorant particles, droplet diameter, and division frequency are in a steady state, without using ink droplets generated immediately after the start of the division of the thread and ejected under the condition that the concentration of the colorant particles, droplet diameter, and division frequency are in an unstable state. Thus, the response to an image signal becomes constant, and an image with higher stability can be formed.

Herein, in the ink jet recording apparatus of the present invention, ink droplets are ejected at all times, and the control is performed in accordance with an image signal by the deflecting means. Therefore, during the ejection of ink droplets, ink droplets are ejected basically from all the ejection portions of the ejection head in a similar manner. Therefore, in the present embodiment, although an ejection electrode is formed for each ejection portion, the present invention is not limited thereto, and a sheet electrode common to multiple ejection portions may be used as the ejection electrode.

Furthermore, the bias voltage applied to the ejection electrode is not limited to a DC voltage, and a pulse voltage can also be used.

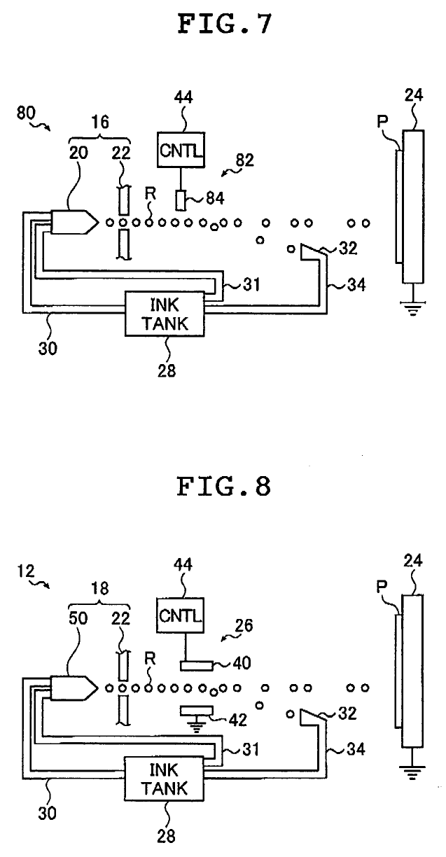

FIG. 7 shows another example of the ink jet recording apparatus of the present embodiment.

An ink jet recording apparatus 80 shown in FIG. 7 has the same configuration as that of the ink jet recording apparatus 10 shown in FIG. 1, except for deflecting means 82. Thus, the same components are denoted with the same reference numerals, and the detailed description thereof is omitted here. Hereinafter, points peculiar to the ink jet recording apparatus 80 will be described mainly.

The deflecting means 82 of the ink jet recording apparatus 80 comprises an airstream generating unit 84 and the control unit 44. The airstream generating unit 84 is connected to the control unit 44.

The airstream generating unit 84 ejects an airstream to the ink droplets R, thereby deflecting the ink droplets R. Furthermore, the control unit 44 controls an airstream ejected from the airstream generating unit 84 in accordance with an image signal.

The ink droplets R deflected with the airstream ejected from the airstream generating unit 84 are recovered in the gutter 32, and the ink droplets R that have not been deflected fly straight and land on the recording medium P, thereby forming an image.

Thus, the deflecting means is not limited to means for deflecting ink droplets by forming a predetermined electric field through application of a voltage to the deflection electrode. The deflecting means may deflect ink droplets with an airstream to control the behavior of the ink droplets in accordance with an image signal.

Furthermore, the deflecting means is not limited to the above-mentioned means for deflecting droplets by forming an electric field or generating an airstream. For example, various deflecting means such as the one for deflecting droplets by forming a magnetic field can be used.

The ink suitably used in the ink jet recording apparatus of the present invention will be described.

The ink Q is obtained by dispersing charged fine particles in a carrier liquid. The carrier liquid is preferably a dielectric liquid having a high electrical resistivity. Preferably, the electrical resistivity of the carrier liquid is not less than 10⁹ Ω·cm but not more than 10¹⁶ Ω·cm, and more preferably not less than 10¹⁰ Ω·cm but not more than 10¹⁵ Ω·cm. Such a range is selected for the electrical resistivity of the carrier liquid, whereby the charged fine particles are easily concentrated. As a result, it is possible to form deep color dots with less bleeding, and upon ejection of ink, the voltage is prevented from becoming too high.

The relative permittivity of the dielectric liquid used as the carrier liquid is preferably not less than 1.9 but not more than 5.0, and more preferably not less than 2 but not more than 4. Such a range is selected for the relative permittivity, whereby the charged fine particles are easily concentrated. As a result, it is possible to form deep color dots with less bleeding, and upon ejection of ink, the voltage is prevented from becoming too high.

Preferred examples of the dielectric liquid used as the carrier liquid include straight-chain or branched aliphatic hydrocarbons, alicyclic hydrocarbons, aromatic hydrocarbons, and the same hydrocarbons substituted with halogens. Specific examples thereof include hexane, heptane, octane, isooctane, decane, isodecane, decalin, nonane, dodecane, isododecane, cyclohexane, cyclooctane, cyclodecane, benzene, toluene, xylene, mesitylene, Isopar C, Isopar E, Isopar G, Isopar H, Isopar L, Isopar M (Isopar: a trade name of EXXON Corporation), Shellsol 70, Shellsol 71 (Shellsol: a trade name of Shell Oil Company), AMSCO OMS, AMSCO 460 Solvent (AMSCO: a trade name of Spirits Co., Ltd.), a silicone oil (such as KF-96L, available from Shin-Etsu Chemical Co., Ltd.). The dielectric liquid may be used singly or as a mixture of two or more thereof.

Colorants may be contained in the charged fine particles dispersed in the carrier liquid. For such charged particles containing colorants (colorant particles), colorants themselves may be dispersed as the colorant particles into the carrier liquid, but dispersion resin particles are preferably contained for enhancement of fixing property. In the case where the dispersion resin particles are contained in the carrier liquid, in general, there is adopted a method in which pigments are covered with the resin material of the dispersion resin particles to obtain particles covered with the resin, or the dispersion resin particles are colored with dyes to obtain the colored particles.

As the colorants, pigments and dyes conventionally used in ink compositions for ink jet recording, (oily) ink compositions for printing, or liquid developers for electrostatic photography may be used.

Pigments used as colorants may be inorganic pigments or organic pigments commonly employed in the field of printing technology. Specific examples thereof include but are not particularly limited to known pigments such as carbon black, cadmium red, molybdenum red, chrome yellow, cadmium yellow, titanium yellow, chromium oxide, viridian, cobalt green, ultramarine blue, Prussian blue, cobalt blue, azo pigments, phthalocyanine pigments, quinacridone pigments, isoindolinone pigments, dioxazine pigments, threne pigments, perylene pigments, perinone pigments, thioindigo pigments, quinophthalone pigments, and metal complex pigments.

Preferred examples of dyes used as colorants include oil-soluble dyes such as azo dyes, metal complex salt dyes, naphthol dyes, anthraquinone dyes, indigo dyes, carbonium dyes, quinoneimine dyes, xanthene dyes, aniline dyes, quinoline dyes, nitro dyes, nitroso dyes, benzoquinone dyes, naphthoquinone dyes, phthalocyanine dyes, and metal phthalocyanine dyes.

Further, examples of dispersion resin particles include rosins, rosin-modified phenol resin, alkyd resin, a (meth)acryl polymer, polyurethane, polyester, polyamide, polyethylene, polybutadiene, polystyrene, polyvinyl acetate, acetal-modified polyvinyl alcohol, and polycarbonate.

Of those, from the viewpoint of ease for particle formation, a polymer having a weight average molecular weight in a range of 2,000 to 1,000,000 and a polydispersity (weight average molecular weight/number average molecular weight) in a range of 1.0 to 5.0 is preferred. Moreover, from the viewpoint of ease for the fixation, a polymer in which one of a softening point, a glass transition point, and a melting point is in a range of 40° C. to 120° C. is preferred.

In the ink Q, the content of colorant particles (total content of colorant particles and dispersion resin particles) preferably falls within a range of 0.5 to 30 wt % for the overall ink, more preferably falls within a range of 1.5 to 25 wt %, and much more preferably falls within a range of 3 to 20 wt %. If the content of colorant particles decreases, the following problems become easy to arise. The density of the printed image is insufficient, the affinity between the ink Q and the surface of the recording medium P becomes difficult to obtain to prevent the image firmly stuck to the surface of the recording medium P from being obtained, and so forth. On the other hand, if the content of colorant particles increases, problems occur in that the uniform dispersion liquid becomes difficult to obtain, the clogging of the ink Q is easy to occur in the ink jet head or the like to make it difficult to obtain the consistent ink ejection, and so forth.

In addition, the average particle diameter of the colorant particles dispersed in the carrier liquid preferably falls within a range of 0.1 to 5 μm, more preferably falls within a range of 0.2 to 1.5 μm, and much more preferably falls within a range of 0.4 to 1.0 μm. Those particle diameters are measured with CAPA-500 (a trade name of a measuring apparatus manufactured by HORIBA Ltd.).

After the colorant particles and optionally a dispersing agent are dispersed in the carrier liquid, a charging control agent is added to the resultant carrier liquid to charge the colorant particles, and the charged colorant particles are dispersed in the resultant liquid to thereby produce the ink Q. Note that in dispersing the colorant particles in the carrier liquid, a dispersion medium may be added if necessary.

As the charging control agent, for example, various ones used in the electrophotographic liquid developer can be utilized. In addition, it is also possible to utilize various charging control agents described in “DEVELOPMENT AND PRACTICAL APPLICATION OF RECENT ELECTRONIC PHOTOGRAPH DEVELOPING SYSTEM AND TONER MATERIALS”, pp. 139 to 148; “ELECTROPHOTOGRAPHY-BASES AND APPLICATIONS”, edited by THE IMAGING SOCIETY OF JAPAN, and published by CORONA PUBLISHING CO. LTD., pp. 497 to 505, 1988; and “ELECTRONIC PHOTOGRAPHY” by Yuji Harasaki, 16(No. 2), p. 44, 1977.

Note that the colorant particles may be positively or negatively charged as long as the charged colorant particles are identical in polarity to the bias voltages applied to ejection electrodes.

In addition, the charging amount of colorant particles is preferably in a range of 5 to 200 μC/g, more preferably in a range of 10 to 150 μC/g, and much more preferably in a range of 15 to 100 μC/g.

The electric conductivity of the ink Q is preferably in a range of 100 to 3,000 pS/cm, more preferably in a range of 150 to 2,500 pS/cm, and much more preferably in a range of 200 to 2,000 pS/cm. The range of the electric conductivity as described above is set, resulting in that the applied voltages to the ejection electrodes are not excessively high, and also there is no anxiety to cause the electrical conduction between the adjacent ejection electrodes.

In addition, the surface tension of the ink Q is preferably in a range of 15 to 50 mN/m, more preferably in a range of 15.5 to 45 mN/m, and much more preferably in a range of 16 to 40 mN/m. The surface tension is set in this range, resulting in that the applied voltages to the ejection electrodes are not excessively high, and also the ink does not leak or spread to the periphery of the head to contaminate the head.

Moreover, the viscosity of the ink Q is preferably in a range of 0.5 to 5 mPa·sec, more preferably in a range of 0.6 to 3.0 mPa·sec, and much more preferably in a range of 0.7 to 2.0 mPa·sec.

In addition, the electrical resistance of the dielectric solvent may be changed by adding the charging control agent in some cases. Thus, in order to stabilize the electrical resistivity of the solvent to have a predetermined value, the distribution factor P defined below is preferably equal to or larger than 50%, more preferably equal to or larger than 60%, and much more preferably equal to or larger than 70%.
P=100×(σ1−σ2)/σ1
where σ1 is an electric conductivity of the ink Q, and σ2 is an electric conductivity of a supernatant liquid which is obtained by inspecting the ink Q with a centrifugal separator. Those electric conductivities were measured by using an LCR meter (AG-4311 manufactured by ANDO ELECTRIC CO., LTD.) and electrode for liquid (LP-05 manufactured by KAWAGUCHI ELECTRIC WORKS, CO., LTD.) under a condition of an applied voltage of 5 V and a frequency of 1 kHz. In addition, the centrifugation was carried out for 30 minutes under a condition of a rotational speed of 14,500 rpm and a temperature of 23° C. using a miniature high speed cooling centrifugal machine (SRX-201 manufactured by TOMY SEIKO CO., LTD.).

The ink Q as described above is used, which results in that the colorant particles are likely to migrate and hence the colorant particles are easily concentrated.

The ink Q can be prepared for example by dispersing colorant particles into a carrier liquid to form particles and adding a charging control agent to the dispersion medium to allow the colorant particles to be charged. The following methods are given as the specific methods.

(1) A method including: previously mixing (kneading) a colorant and optionally dispersion resin particles; dispersing the resultant mixture into a carrier liquid using a dispersing agent when necessary; and adding the charging control agent thereto,

(2) A method including: adding a colorant and optionally dispersion resin particles and a dispersing agent in addition to the colorant into a carrier liquid at the same time for dispersion; and adding the charging control agent thereto.

(3) A method including adding a colorant and the charging control agent and optionally the dispersion resin particles and the dispersing agent into a carrier liquid at the same time for dispersion.

Hereinafter, the recording of an image in the ink jet recording apparatus 10 shown in FIG. 1 will be described in detail.

First, ink is circulated from the ink tank 28 by a pump (not shown) through the ink supply flow path 30, the ejection head 20, and the second ink recovery flow path 31 in the stated order, such that a predetermined amount of ink is supplied to the ejection head 20 at all times.

Voltages are applied to the counter electrode 22 and the ejection electrode 58 of the ejection head 20. Because of this, a required potential difference is set between the ejection electrode 58 and the counter electrode 22, and an electric field allowing ink to be ejected from the ejection head 20 is formed. Then, as described above, a Taylor cone is formed followed by the formation of the thread, and division of the thread. The divided thread is ejected as an ink droplet from the ejection port 62. Furthermore, while an electric field allowing ink to be ejected from the ejection head 20 is formed, the division of the thread continuously occurs to form an ink droplet.

The ejected ink droplet passes through the opening 22a formed at a position opposed to the ejection port 62 of the counter electrode 22.

The ink droplet having passed through the counter electrode 22 is attracted to the back electrode 24 side by the action of an electric field formed between the counter electrode 22 supplied with a predetermined voltage and the grounded back electrode 24, and flies straight to the back electrode 24 side to pass between the first deflection electrode 40 and the second deflection electrode 42 of the deflecting means 26.

The ink droplet passing between the first deflection electrode 40 and the second deflection electrode 42 has its behavior (flight path) controlled by the action of an electric field formed between the first deflection electrode 40 and the second deflection electrode 42 through an application of a voltage from the control unit 44 to the first deflection electrode 40 in accordance with an image signal. More specifically, the ink droplet R used for recording an image flies straight to land on the recording medium P without being deflected, and the ink droplet R not used for recording an image is deflected to land on the gutter 32.

Thus, the behavior of the ink droplets R is controlled in accordance with an image signal to allow the ink droplets R to land on the recording medium P, whereby an image is formed on the recording medium P. Furthermore, the ink having landed on the gutter 32 is recovered in the ink tank 28 via the first ink recovery flow path 34 to be reused.

As described above, an image is recorded on a recording medium by ejecting an ink droplet continuously through an application of an electrostatic force to ink, and by controlling the behavior of ink droplets with the deflecting means in accordance with an image signal, whereby an image can be recorded under such a condition that ink droplets are ejected from the ejection head at a high ejection frequency at all times, the response to an image signal is enhanced, and a recording frequency can be increased.

Furthermore, an electrostatic force is applied to ink to allow ink droplets to be ejected, whereby droplets with a minute droplet diameter can be ejected stably at a high ejection frequency, and an image of high quality can be formed stably at high speed.

Next, referring to FIGS. 8 to 16, a fine droplet ejecting device of the second embodiment according to the first aspect of the present invention and an ink jet recording apparatus of the second embodiment according to the second aspect of the present invention will be described.

FIG. 8 is a schematic structural view showing one example of the ink jet recording apparatus of the second embodiment according to the second aspect of the present invention in which the fine droplet ejecting device of the second embodiment according to the first aspect of the present invention is used.

An ink jet recording apparatus 12 shown in FIG. 8 has the same configuration as that of the ink jet recording apparatus 10 shown in FIG. 1, except that an ejection head 50 of ejection means 18 is provided in place of the ejection head 20 of the ejection means 16. The same components are denoted with the same reference numerals, and the detailed description thereof is omitted here.

The ink jet recording apparatus 12 shown in FIG. 8 comprises ejection means 18 composed of an ejection head (ink jet head) 50 having ejection ports for ejecting fine droplets and the counter electrode 22 forming a predetermined electric field between the ejection head 50 and the counter electrode 22, the back electrode 24 for holding the recording medium P, deflecting means 26 for deflecting fine droplets ejected from the ejection head 50, the ink tank 28 and the ink supply flow path 30 for supplying ink to the ejection head 50, and the gutter 32 and the first ink recovery flow path 34 for recovering the fine droplets deflected by the deflecting means 26 in the ink tank 28.

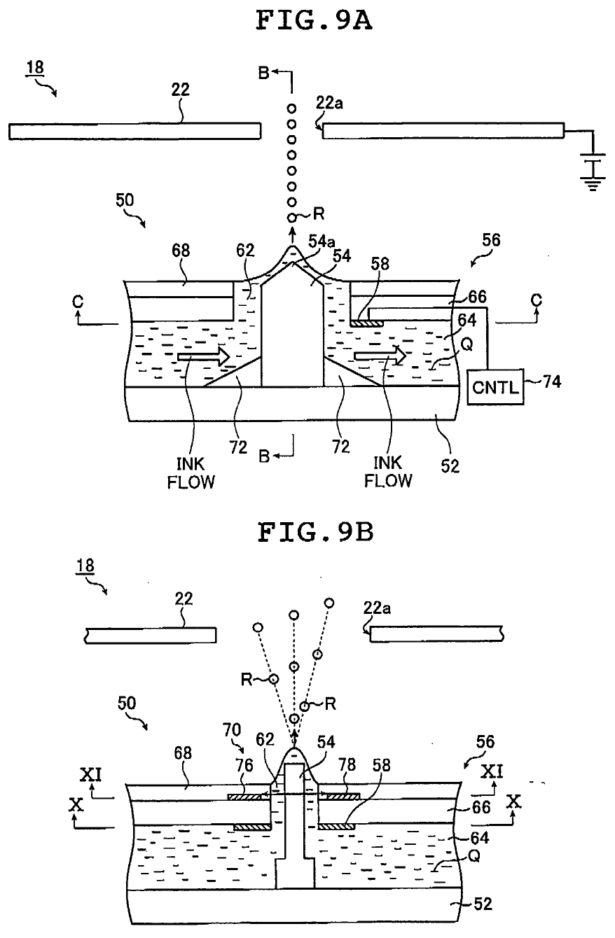

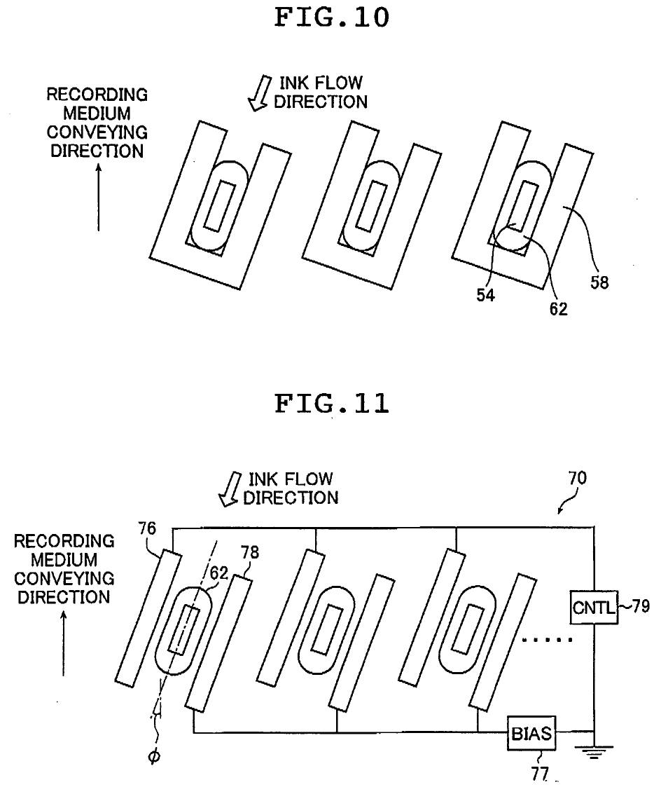

Next, the ejection means 18 will be described in detail, Herein, FIG. 9A is a schematic cross sectional view showing a schematic configuration of the ejection means 18. FIG. 9B is a cross sectional view taken along the line B-B in FIG. 9A. FIG. 10 is a cross sectional view taken along the line X-X in FIG. 9B. The cross sectional view taken along the line C-C in FIG. 9A is the same as FIG. 2B.

Herein, the ejection means 18 shown in FIGS. 9A and 9B has the same configuration as that of the ejection means 16 shown in FIG. 2A, except that the ejection head 50 is provided in place of the ejection head 20. The ejection head 50 of the ejection means 18 shown in FIGS. 9A and 9B has the same configuration as that of the ejection head 20 of the ejection means 16 shown in FIG. 2A, except that a first control electrode 76 and a second control electrode 78 constituting resolution enhancing means 70 is provided in place of the guard electrode 60. Thus, the same components are denoted with the same reference numerals, and the detailed description thereof is omitted here.

The ejection means 18 comprises the ejection head 50 and the counter electrode 22 placed at a position opposed to the surface of the ejection head 50 on the ink ejection side.

The ejection head 50 forms an electric field with a predetermined intensity between the counter electrode 22 and the ejection head 50, thereby allowing an ink droplet with a minute droplet diameter to be ejected continuously. The ejection head 50 comprises the head substrate 52, the ink guides 54, the resolution enhancing means 70 and the ejection port substrate 56 in which the ejection ports 62 are formed. On the ejection port substrate 56, the ejection electrodes 58 are placed so as to surround the respective ejection port 62 (see FIG. 2B).

In FIGS. 9A and 9B, for ease of understanding on the configuration of the ink jet head, only one of the multiple ejection ports 62 is shown. However, as schematically shown in FIG. 10, it is preferable that the ejection head 50 have a single line structure in which multiple ejection ports (nozzles) 62 are arranged in a single line on the ejection port substrate 56 so as to record an image at high speed. As shown in FIG. 10, the ejection ports 62 of the present embodiment are placed inclined at a predetermined angle (φ in this embodiment) with respect to the conveying direction of the recording medium P. More specifically, in the present embodiment, even in the case of the ejection head 50 with a single line structure shown in FIG. 10, the ejection ports 62 are formed so that the longitudinal direction of the elongated cocoon-shaped slit of each ejection port 62 is parallel to the ink flow direction, as shown in FIG. 2B. However, as shown in FIG. 10, the ejection ports 62 are placed inclined at a predetermined angle (φ) with respect to the conveying direction of the recording medium P. Therefore, in the ejection head 50, center positions of multiple ejection ports 62 are arranged in a line in a direction orthogonal to the conveying direction of the recording medium P. Accordingly, it is preferable that multiple ejection ports 62 be formed so as to be arranged in a single line in parallel with one another, inclined at a predetermined angle (φ). This point will be described in detail.

Even in the ejection head 50 of the present embodiment, in the same way as in the ejection head 20 shown in FIG. 3, the number of the ejection ports 62, the physical arrangement position thereof and the like can be selected freely. For example, the ejection head 50 may have a multi-line structure instead of a single line structure shown in FIG. 10. The ejection head 50 may also be a so-called serial head (shuttle type) which performs scanning in a direction orthogonal to a nozzle line direction. Furthermore, even in the ejection head 50, as in the case of the ejection head 20 shown in FIG. 2A, the ink Q in which colorant particles are dispersed in a carrier liquid can be used.

Hereinafter, the configuration of the ejection head 50 of the present invention shown in FIGS. 9A and 9B will be described in more detail, mainly with respect to the resolution enhancing means 70, which is the feature of the ejection head 50.

As shown in FIGS. 9A and 9B, the ejection port substrate 56 of the ejection head 50 comprises the insulating substrate 66, the first control electrode 76 and the second control electrode 78 constituting the resolution enhancing means 70, the ejection electrode 58, and the insulating layer 68. On an upper surface of the insulating substrate 66 in FIG. 9B (i.e., the surface opposite to a surface opposed to the head substrate 52), the first control electrode 76 and the second control electrode 78 of the resolution enhancing means 70, and the insulating layer 68 are laminated in order. Furthermore, on a lower surface of the insulating substrate 66 in FIG. 9A (i.e., the surface opposed to the head substrate 52), the ejection electrode 58 is formed.

The resolution enhancing means 70 comprises the first control electrode 76, the second control electrode 78 and the control unit (CNTL) 79. The first control electrode 76 and the second control electrode 78 are formed on the surface of the insulating substrate 66, and the surfaces of the first control electrode 76 and the second control electrode 78 are covered with the insulating layer 68. FIG. 11 schematically shows a planar configuration of the first control electrode 76 and the second control electrode 78. FIG. 11 is a view taken along the line XI-XI in FIG. 9B, and schematically shows a planar configuration of the first control electrode 76 and the second control electrode 78 in the case of an ink jet head having a single line structure as shown in FIG. 10. Herein, the vertical direction in FIG. 11 corresponds to the relative conveying direction of the recording medium P.

As shown in FIG. 11, a pair of the first control electrode 76 and the second control electrode 78 in the resolution enhancing means 70 is provided to correspond to one ejection port 62, and respectively have an elongated rectangular shape with a long side being longer than the length of the elongated cocoon-shaped slit of the ejection port 62 in the longitudinal (long side) direction. The first control electrode 76 is placed on the downstream side of the ejection port 62 in the conveying direction of the recording medium P, and the second control electrode 78 is placed on the upstream side of the ejection port 62 in the conveying direction of the recording medium P. The first control electrode 76 and the second control electrode 78 are placed in parallel on both sides of the ejection port 62 along the longitudinal (long side) direction thereof. More specifically, as shown in FIG. 11, the first control electrode 76 and the second control electrode 78 of the resolution enhancing means 70 are formed so that the longitudinal directions thereof are parallel to the ink flow direction that is the longitudinal direction of the elongated cocoon-shaped slit of the ejection port 62. Thus, as is apparent from the arrangement of multiple ejection ports 62 of the ejection head 50 having a single line structure shown in FIG. 10, the first control electrode 76 and the second control electrode 78 are also placed inclined at a predetermined angle (φ) with respect to the conveying direction of the recording medium P.

Each first control electrode 76 of the resolution enhancing means 70 is connected to the control unit 79, and each second control electrode 78 is electrically grounded through a bias supply (BIAS) 77 for supplying a predetermined bias voltage.

In synchronization with the ejection timing of an ink droplet, the control unit 79 applies a predetermined voltage to the first control electrode 76 to form a predetermined electric field between the first control electrode 76 and the second control electrode 78. That is, a predetermined electric field is formed in a short side direction (direction represented by an arrow in FIG. 9B) of the ejection port 62, whereby the ejection direction (flight direction) of ink droplets ejected from the ejection port 62 is controlled, and the ink droplets are deflected in multiple directions as shown in FIG. 9B. A control method will be described later.

Herein, the first control electrode 76 and the second control electrode 78 have a rectangular shape. However, the shape thereof is not particularly limited as long as a predetermined electric field can be formed in a short side direction of the ejection port 62, and various kinds of shapes such as a semicircular shape or an oval shape can be used. Furthermore, the first control electrode 76 and the second control electrode 78 are preferably symmetrical with respect to a symmetry axis which passes through the center of the ejection port and is parallel to the longitudinal direction thereof. However, the present invention is not limited thereto. It may be such that the first control electrode has a shape asymmetrical to that of the second control electrode. For example, the first control electrode may have a rectangular shape and the second control electrode may have a semicircular shape.

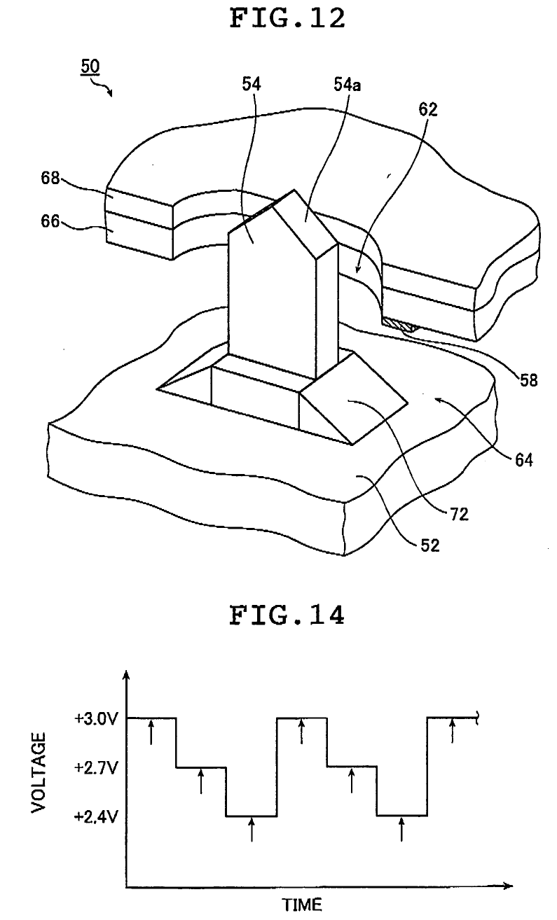

Furthermore, as shown in FIG. 12, in the ejection head 50 of the present embodiment, similar to the ejection head 20 of the first embodiment shown in FIG. 5A, as a preferable form, the ink guide dikes 72 that induce the ink to the ejection port 62 are provided on the head substrate 52.

FIG. 12 is a partial cross sectional perspective view showing a configuration in the vicinity of the ejection portion in the ejection head 50 in FIG. 9A, and for the sake of clarity of the configuration of the ink guide dikes 72, the ejection port substrate 56 is shown under the condition of being cut along the ink flow direction at a nearly central position of the ink guide 54. Therefore, FIG. 12 does not show the first control electrode 76 and the second control electrode 78 of the resolution enhancing means 70. Although the ejection head 50 shown in FIG. 12 does not have the guard electrode 60 unlike the ejection head 20 shown in FIG. 5A, it need only to have the ink guide dikes 72 with the similar configuration.

In the ejection head 50 shown in FIG. 12, the ink guide dikes 72 inclining toward the ejection port 62 are provided on the bottom surface of the ink flow path 64 along the ink flow direction, whereby the ink flow directed to the ejection port 62 is formed and hence the ink Q is guided to the opening portion of the ejection port 62 on the side of the ink flow path 64. Thus, even in the case of the ejection head 50, it is possible to suitably make the ink Q to flow to the inside of the ejection port 62, and it is also possible to enhance the supplying property of the ink Q. Further, it is possible to more surely prevent the ejection port 62 from being clogged.

As shown in FIG. 9A, in the ejection means 18 of the present embodiment, in the same way as in the case of the ejection head 20 of the ejection means 16 of the first embodiment shown in FIG. 2A, the counter electrode 22 is disposed so as to be opposed to the ejection surface of the ink droplets of the ejection head 50. Thus, even in the electrostatic ink jet head of the present embodiment using the ejection means 18 of the present embodiment and the ink Q containing charged colorant particles, in the same way as in the electrostatic ink jet head using the ejection means 16 of the first embodiment shown in FIG. 2A, the ink can be allowed to fly through an application of a force to colorant particles that are solid components dispersed in a carrier liquid.

Hereinafter, the ejection action of the ink droplets R from the ejection head 50 of the ejection means 18 of the present embodiment shown in FIG. 9A will be described.

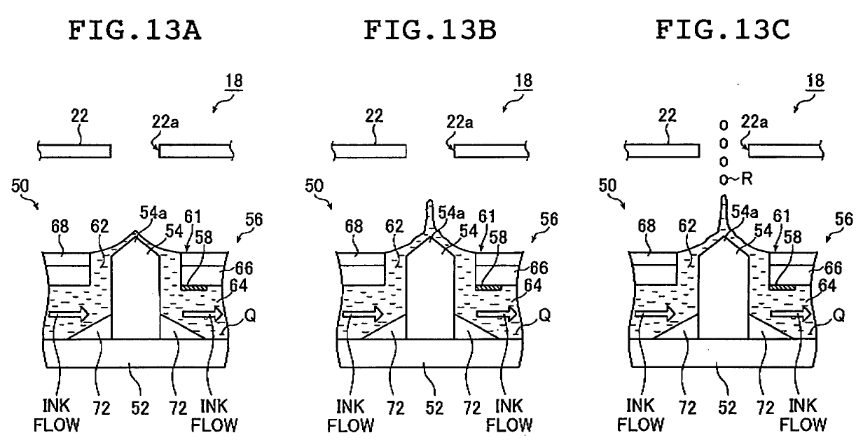

First, referring to FIGS. 13A, 13B, and 13C, the ejection action of the ink droplets R from the ejection head 50 shown in FIG. 9A will be described. The resolution enhancing means 70 of the ejection head 50 acts in a direction vertical to the drawing surfaces of FIGS. 13A to 13C. Therefore, the basic ejection action of the ink droplets R described with reference to FIGS. 13A to 13C is the same as that in the ejection head 20 shown in FIGS. 6A, 6B and 6C.

Even in the ejection head 50 shown in FIG. 9A, the ink Q, which contains colorant particles charged with a voltage having the same polarity as that of a voltage applied to the ejection electrode 58 at a time of ejection of ink droplets, is supplied from the ink supply flow path 30 (see FIG. 8), and circulates in the ink flow path 64 in an arrow direction.

On the other hand, upon recording, a voltage with the same polarity as that of the colorant particles, i.e., a predetermined positive voltage is applied to the counter electrode 22 from the voltage source.

At a time of ejection of ink droplets, the control unit 74 performs control so that a predetermined bias voltage is further applied to the ejection electrode 58.

Immediately after the application of the bias voltage, various forces such as an electrostatic force, e.g., Coulomb attraction between the bias voltage and the charges of the colorant particles of the ink Q, act on the ink Q. Then, the colorant particles and the carrier liquid move to form a meniscus shape in which the ink Q slightly rises from the ejection port 62 as conceptually shown in FIG. 13A. Furthermore, the Coulomb attraction and the like allow the colorant particles to move toward the counter electrode 22 through a so-called electrophoresis process. Therefore, the ink Q is concentrated at the meniscus.

When a finite period of time further elapses after the start of the application of the bias voltage to the ejection electrode 58, the balance of the force is broken at the tip portion of the meniscus having the high electric field strength due to the movement of the colorant particles or the like. As a result, the meniscus abruptly grows to form a slender ink liquid column called the thread having about several μm to several tens of μm in diameter as conceptually shown in FIG. 13B.

When a finite period of time further elapses, the thread grows, and is divided due to the interaction among various factors such as the growth of the thread. As shown in FIG. 13C, the divided thread is then ejected and flown in the form of the ink droplet R toward the counter electrode 22 to pass through the opening 22a formed in the counter electrode 22. The growth of the thread and its division, and moreover the movement of the colorant particles to the meniscus (thread) are continuously generated while the bias voltage is applied to the ejection electrode.

Then, after a lapse of predetermined time from the application of the bias voltage, the amount of the ink Q supplied to the ejection port 62 and the amount of the ink Q divided and ejected become equilibrium state, and during the application of the bias voltage, the fine ink droplets R with a constant concentration of the colorant particles and uniform droplet diameter are ejected at a constant division frequency.

Thus, even in this electrostatic ink jet head (ejection head 50), through an application of an electrostatic force to the ejection port 62, ink droplets having a diameter smaller than the opening diameter of the ejection port 62 can be ejected stably in the similar way. Because of this, the electrostatic ink jet head can eject the ink droplets R having a very small droplet diameter.

Herein, the control unit 79 of the resolution enhancing means 70 periodically switches voltages applied to the first control electrodes 76 in synchronization with the ejection timing of the ink droplets R while the ink droplets R are being ejected, and forms an electric field whose direction is switched periodically in the short side direction (horizontal direction in FIG. 9B, i.e., direction vertical to the drawing surfaces of FIGS. 9A and FIGS. 13A to 13C) of the ejection port 62. Owing to the electric field whose direction changes periodically, the flight direction of the ink droplets R is deflected in the short side direction of the ejection port 62, i.e., in the direction orthogonal to the longitudinal direction of the first control electrode and the second control electrode of the resolution enhancing means 70, whereby the ink droplets R are ejected periodically in multiple directions.

Next, a method of controlling the flight direction (ejection direction) of the ink droplets R will be described by way of a specific example.

FIG. 14 shows a voltage waveform of a voltage applied to the first control electrode 76 of the resolution enhancing means 70 of the ejection head 50 shown in FIG. 9B and an ejection timing of an ink droplet. In FIG. 14, a vertical axis shows a voltage applied to the first control electrode 76, a horizontal axis shows a time, and an arrow represents a timing at which an ink droplet is ejected from the ejection head 50.

Herein, in the present embodiment, a predetermined voltage lower than the voltage applied to the ejection electrode 58, i.e., a predetermined voltage between the voltage applied to the ejection electrode 58 and the voltage applied to the counter electrode (2.7 kV in the present embodiment) is applied to the second control electrode 78.

Furthermore, as shown in FIG. 14, the first control electrode 76 is repeatedly supplied with three kinds of voltages: a predetermined voltage (+3.0 kV in the present example) higher than the voltage applied to the second control electrode 78; a predetermined voltage (+2.7 kV in the present example) that is the same as the voltage applied to the second control electrode 78; and a predetermined voltage (+2.4 kV in the present embodiment) lower than the voltage applied to the second control electrode 78, in synchronization with the ejection timing of an ink droplet, in the following order; the predetermined voltage higher than the voltage applied to the second control electrode 78; the predetermined voltage that is the same as the voltage applied to the second control electrode 78; and the predetermined voltage lower than the voltage applied to the second control electrode 78. That is, every time one ink droplet is ejected, the voltage applied to the first control electrode 76 is switched.

First, when the predetermined voltage higher than the voltage applied to the second control electrode 78 is applied to the first control electrode 76, a predetermined electric field is formed between the first control electrode 76 and the second control electrode 78. An ink droplet (charged positively in the present embodiment) ejected at a time when this electric field is formed receives a force acting in a direction from the first control electrode 76 to the second control electrode 78. Because of this, the ink droplet is ejected in the direction inclined to the second control electrode 78 side at a predetermined angle with respect to the direction vertical to an opening surface of the ejection port.

Next, when the predetermined voltage that is the same as the voltage applied to the second control electrode 78 is applied to the first control electrode 76, the first control electrode 76 and the second control electrode 78 reach the same potential. The ink droplet ejected in this state flies in a direction vertical to the opening surface of the ejection port.

Further, when the predetermined voltage lower than the voltage applied to the second control electrode 78 is applied to the first control electrode 76, a predetermined electric field is formed between the first control electrode 76 and the second control electrode 78. An ink droplet ejected at a time when this electric field is formed receives a force acting in a direction from the second control electrode 78 to the first control electrode 76. Because of this, the ink droplet is ejected in the direction inclined to the first control electrode 76 side at a predetermined angle with respect to the direction vertical to an opening surface of the ejection port.

Thus, in synchronization with the ejection timing of an ink droplet, the predetermined voltage higher than the voltage applied to the second control electrode 78, the predetermined voltage that is the same as the voltage applied to the second control electrode 78, and the predetermined voltage lower than the voltage applied to the second control electrode 78 are applied to the first control electrode 76 at intervals of a predetermined period. Because of this, as shown in FIG. 9B, ink droplets are deflected and ejected from the ejection portion periodically in three directions: the direction inclined to the second control electrode 78 side at a predetermined angle with respect to the direction vertical to the opening surface of the ejection port; the direction vertical to the opening surface of the ejection port; and the direction inclined to the first control electrode 76 side at a predetermined angle with respect to the direction vertical to the opening surface of the ejection port. The ink droplets which were deflected and ejected pass through the opening 22a of the counter electrode 22, and fly toward the back electrode 24.

Referring to FIG. 8 again, description of the ink jet recording apparatus 12 will be continued.

The back electrode 24 placed in parallel with the counter electrode 22 at a position opposed to the ejection head 50 across the counter electrode 22 holds the recording medium P on the surface on the ejection head 50 side.

Herein, the back electrode 24 is grounded, a predetermined positive voltage is applied to the counter electrode 22, and a positive bias voltage is applied to the ejection electrode 58, whereby predetermined electric fields are formed between the counter electrode 22 and the back electrode 24, and between the ejection electrode 58 and the counter electrode 22.

The ink droplet R that was ejected from the ejection head 50 by the action of the electric field formed between the ejection electrode 58 and the counter electrode 22 and passed through the opening 22a of the counter electrode 22 is attracted to the back electrode 24 side, i.e., the recording medium P side by the action of the electric field formed between the counter electrode 22 and the back electrode 24, and flies straight toward the back electrode 24.

The deflecting means 26 comprises the first deflection electrode 40, the second deflection electrode 42, and the control unit 44 placed across the flight paths of the ink droplets R between the counter electrode 22 and the back electrode 24.

Herein, the first deflection electrode 40 and the second deflection electrode 42 are placed substantially at a right angle with respect to the longitudinal direction of the first control electrode 76 and the second control electrode 78, i.e., substantially in parallel with the plane passing through the flight paths of ink droplets ejected in three directions from the ejection means 18. Furthermore, the first deflection electrode 40 is connected to the control unit 44, and the second deflection electrode 42 is electrically grounded.

The control unit 44 controls a voltage applied to the first deflection electrode 40 in accordance with an image signal, and forms an electric field between the first deflection electrode 40 and the second deflection electrode 42. Herein, a voltage having the same polarity as that of the ink droplets R is applied from the control unit 44 to the first deflection electrode 40 in accordance with an image signal.

The ink droplets R ejected from the ejection head 50 under the condition of being deflected in three directions pass through the opening 22a (see FIGS. 9A and 98) formed on the flight paths of ink droplets in the counter electrode 22. After this, the ink droplets R fly straight toward the back electrode 24 to pass between the first deflection electrode 40 and the second deflection electrode 42. Herein, the ink droplets R passing between the first deflection electrode 40 and the second deflection electrode 42 under the application of a voltage from the control unit 44 receive a force acting in a direction from the first deflection electrode 40 to the second deflection electrode 42 by the action of the electric field formed between the first deflection electrode 40 and the second deflection electrode 42, and the flight path is deflected at a predetermined angle to the second deflection electrode 42 side. That is, the deflecting means 26 deflects the flight paths of ink droplets in a direction different from the direction in which the ink droplets are deflected by the resolution enhancing means 70.

Furthermore, the ink droplets R passing between the first deflection electrode 40 and the second deflection electrode 42 in the absence of a voltage fly straight to the back electrode 24 without having its flight path deflected, and land on the recording medium P.

The ink droplets having its flight paths deflected by the deflecting means 26 land on the gutter 32, and are recovered in the ink tank 28 from the gutter 32 via the first ink recovery flow path 34.

The ink tank 28 stores ink. The ink tank 28 is connected to the ejection head 50 via the ink supply flow path 30 and the second ink recovery flow path 31, and is connected to the gutter 32 via the first ink recovery flow path 34.

Hereinafter, the flight paths of ink droplets ejected under the condition of being deflected in multiple directions in the ink jet recording apparatus shown in FIG. 8 will be described in more detail.

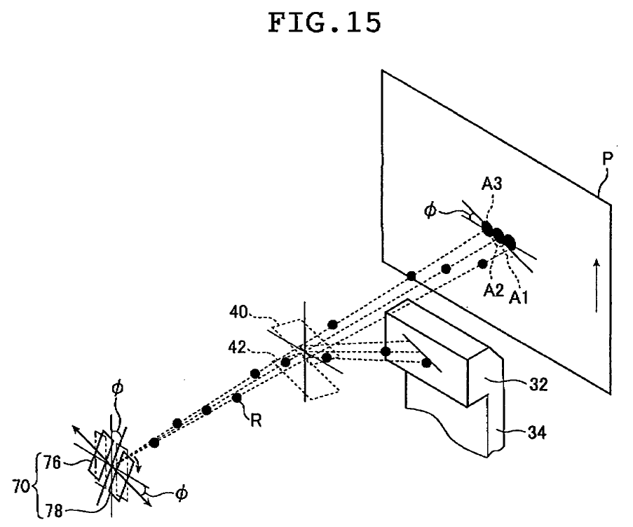

FIG. 15 is an explanatory view schematically showing flight paths of ink droplets from the ejection head 50 to the recording medium P or to the gutter 32 in the ink jet recording apparatus shown in FIG. 8. In FIG. 15, for clearly showing the flight paths of ink droplets, the first control electrode 76 and the second control electrode 78 are schematically shown, the other ejection means 18 is omitted, and the first deflection electrode 40 and the second deflection electrode 42 are represented by a dotted line. Furthermore, in a case where the conveying direction of the recording medium P and the longitudinal directions of the first control electrode 76 and the second control electrode 78 are parallel to one another, the first control electrode 76 and the second control electrode 78 are represented by a phantom line. Furthermore, the flight paths of the ink droplets R are also represented by a dotted line.

As shown in FIGS. 10 and 11 described above, the ejection ports of the ejection portions of the ejection means 18, and the longitudinal direction of the first control electrodes and the second control electrodes are placed so as to be inclined at a predetermined angle (angle φ in the present embodiment) with respect to the conveying direction of the recording medium. Because of this, as shown in FIG. 15, ink droplets ejected from the ejection means 18 are ejected under the condition of being deflected in multiple directions on a plane inclined at a predetermined angle (angle φ in the present embodiment) with respect to the direction orthogonal to the conveying direction of the recording medium P.

Thus, an ink droplet deflected in a direction inclined at a predetermined angle to the second control electrode 78 side lands on an upstream side (A1 in FIG. 15) at a predetermined distance from a position (A2 in FIG. 15) where an ink droplet ejected vertically from the ejection portion lands in the conveying direction of the recording medium P. Furthermore, an ink droplet deflected in a direction inclined at a predetermined angle to the first control electrode 76 side lands on a downstream side (A3 in FIG. 15) at a predetermined distance from a position (A2 in FIG. 15) where an ink droplet ejected vertically from the ejection portion lands in the conveying direction of the recording medium P.

Because of this, in a case where an ink droplet ejected continuously in the following order: the direction inclined at a predetermined angle to the second control electrode side; the direction vertical to the ejection portion; and the direction inclined at a predetermined angle to the first control electrode side, lands on the recording medium P, the landing position moves from an upstream to a downstream in the conveying direction of the recording medium P, and the recording medium P is also conveyed in the direction represented by the arrow in FIG. 15 at a predetermined speed, whereby ink droplets land on the recording medium P in one line in the direction orthogonal to the conveying direction of the recording medium P.

Thus, by adjusting an angle at which the ejection port of the ejection portion and the longitudinal direction of the first control electrode and the second control electrode are inclined with respect to the conveying direction of the recording medium P in accordance with the ejection interval and the flight speed of ink droplet, the conveying speed of the recording medium P, and the like, ink droplets ejected in multiple directions periodically from one ejection portion is allowed to land on the recording medium P in one line in a direction orthogonal to the conveying direction of the recording medium P. This enables a line drawing such as a character to be formed with high quality.

As described above, the ink jet recording apparatus 12 of the present embodiment is also a continuous ink jet recording apparatus in which an ink droplet is ejected continuously through an application of an electrostatic force to the ejection head 50, and the ink droplets are deflected selectively by the deflecting means in accordance with an image signal to control the ink droplets to be landed on a recording medium, thereby forming an image.

Thus, as in the case of the ink jet recording apparatus of the first embodiment, by using the electrostatic and continuous ink jet recording apparatus as the ink jet recording apparatus of the present embodiment, recording can be performed under the condition that ink droplets are always ejected from the ejection head, which enhances the response to an image signal and increases a recording frequency.

Furthermore, the ink jet recording apparatus of the present embodiment can also obtain various effects similar to those of the ink jet recording apparatus of the first embodiment.

Furthermore, in addition to these effects, the ink jet recording apparatus of the present embodiment can provide image recording with a resolution higher than that of the arrangement density of the ejection ports, by ejecting ink droplets while deflecting them by the resolution enhancing means, i.e., by allowing ink droplets to be ejected in multiple directions from one ejection port. Because of this, even in a case where the arrangement density of the ejection ports (ejection portions) is low, an image with a high resolution can be recorded. Furthermore, even in a case of recording an image with a high resolution, adjacent ejection ports can be arranged at a predetermined distance apart. Accordingly, upon ejecting ink droplets in which the colorant particles are concentrated, it is possible to prevent charge repulsion and the like from occurring among ink droplets ejected from adjacent ejection ports due to a large amount of charges of the ink droplets to be ejected, and thus the landing positions of the ink droplets are prevented from being shifted. Thus, ink droplets can land on a recording medium with accuracy, an image with a higher resolution can be formed with high precision, and a configuration of the apparatus can be made further simplified.

Furthermore, by placing the first deflection electrode 40 and the second deflection electrode 42 at a right angle with respect to the first control electrode 76 and the second control electrode 78, ink droplets flying in multiple directions from one ejection portion can be deflected by a set of the first deflection electrode 40 and the second deflection electrode 42. This can simplify the configuration of the apparatus, and the distance between the ink droplet, and the first and second deflection electrodes 40 and 42 becomes constant, whereby the flight path of an ink droplet can be controlled with more accuracy.

In the present embodiment, although ink droplets are ejected under the condition of being deflected in three directions by the resolution enhancing means 70, the number of directions in which ink droplets are deflected is not limited to three. By controlling the voltages applied to the first control electrode 76 and the second control electrode 78 so as to adjust an electric field to be formed, ink droplets can be ejected under the condition of being deflected in the arbitrary number of directions such as two directions and five directions.

Furthermore, in the present embodiment, although the ejection direction of ink droplet is deflected every time one ink droplet is ejected, the ejection direction may be deflected every time the predetermined number of droplets are ejected.

Furthermore, it is preferable that the first control electrodes and the second control electrodes of the resolution enhancing means be provided on the ejection port substrate as in the present embodiment in terms of the ease of setting and the like. However, the present invention is not limited thereto, and the first and second control electrodes may be provided at any positions as long as they are arranged between the ejection port substrate and the counter electrode.

Furthermore, in the present embodiment, although the voltage applied to the first control electrode is controlled while a predetermined constant voltage being applied to the second control electrode, the present invention is not limited thereto. A predetermined constant voltage may be applied to the first control electrode while the voltage applied to the second control electrode being controlled. It is also possible to control both the voltages applied to the first control electrode and the second control electrode.

Further, there is also no particular limit to the voltage applied to the first deflection electrode 40 and the second deflection electrode 42. For example, ink droplets may be deflected by the action of an electric field formed by grounding the first deflection electrode 40 and applying a voltage having a polarity different from that of the ink droplets to the second deflection electrode 42.

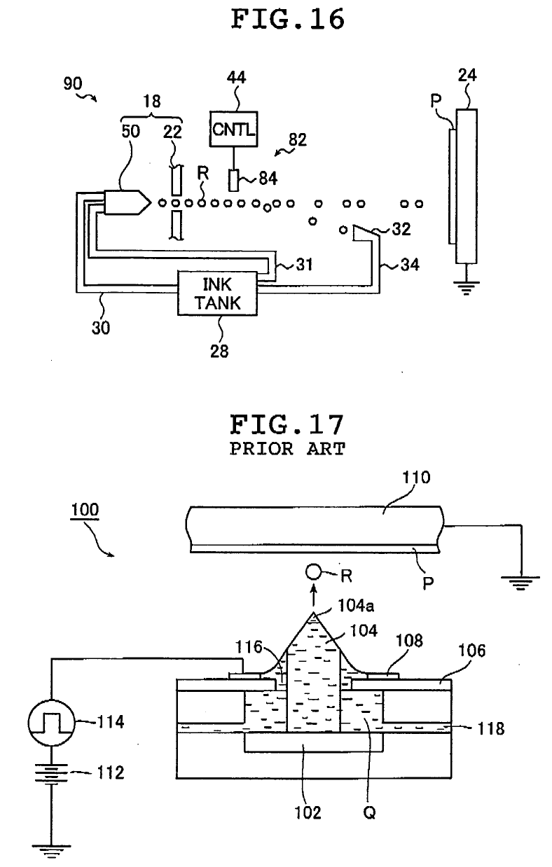

FIG. 16 shows another example of the ink jet recording apparatus of the present embodiment.

An ink jet recording apparatus 90 shown in FIG. 16 has the same configuration as that of the ink jet recording apparatus shown in FIG. 8 except for a configuration of the deflecting means 82. The deflecting means 82 has the same configuration as that of the ink jet recording apparatus 80 shown in FIG. 7. Thus, the same components among these three apparatuses are denoted with the same reference numerals, and the description thereof is omitted.

Even in the ink jet recording apparatus 90 of the present embodiment, the ejection effects similar to those of the ink jet recording apparatus 12 shown in FIG. 8 can be obtained, and the deflection effects of the ink droplets R similar to those of the deflecting means 82 of the ink jet recording apparatus 80 shown in FIG. 7 can be obtained.

Even in the present embodiment, the deflecting means is not limited to those for applying voltages to the deflection electrodes 40 and 42 to form a predetermined electric field, thereby deflecting an ink droplet as in the deflecting means 26 shown in FIGS. 1 and 8. The behavior of an ink droplet can be controlled in accordance with an image signal by deflecting an ink droplet with an airstream as in the deflecting means 82 shown in FIGS. 7 and 16.

Furthermore, the deflecting means applicable to the ink jet recording apparatus of the present embodiment is not limited to the above-mentioned deflecting means. For example, various deflecting means such as those for deflecting droplets by forming a magnetic field can be used.

Hereinafter, the recording of an image in the ink jet recording apparatus 12 of the present embodiment will be described in detail.

First, ink is circulated from the ink tank 28 by a pump (not shown) through the ink supply flow path 30, the ejection head 50, and the first ink recovery flow path 31 in the stated order, such that a predetermined amount of ink is supplied to the ejection head 50 at all times.

Voltages are applied to the counter electrode 22 and the ejection electrode 58 of the ejection head 50. Because of this, a required potential difference is set between the ejection electrode 58 and the counter electrode 22, and an electric field allowing ink to be ejected from the ejection head 50 is formed. Then, as described above, a Taylor cone is formed followed by the formation of the thread, and division of the thread. The divided thread is ejected as an ink droplet from the ejection port 62. Furthermore, while an electric field allowing ink to be ejected from the ejection head 50 is formed, the division of the thread continuously occurs to form an ink droplet. Furthermore, the ink droplets are deflected by the resolution enhancing means 70, and ejected in multiple directions.

The ink droplets ejected in multiple directions pass through the opening 22a formed at a position opposed to the ejection port 62 of the counter electrode 22.

The ink droplets having passed through the counter electrode 22 are attracted to the back electrode 24 side by the action of an electric field formed between the counter electrode 22 supplied with a predetermined voltage and the grounded back electrode 24, and fly straight to the back electrode 24 side to pass between the first deflection electrode 40 and the second deflection electrode 42 of the deflecting means 26.

The ink droplets passing between the first deflection electrode 40 and the second deflection electrode 42 have its behavior (flight path) controlled by the action of an electric field formed between the first deflection electrode 40 and the second deflection electrode 42 through an application of a voltage from the control unit 44 to the first deflection electrode 40 in accordance with an image signal. More specifically, the ink droplets R used for recording an image fly straight to land on the recording medium P without being deflected, and the ink droplets R not used for recording an image are deflected to land on the gutter 32.

Thus, the behavior of the ink droplets R is controlled in accordance with an image signal to allow the ink droplets R to land on the recording medium P, whereby an image is formed on the recording medium P. Furthermore, the ink having landed on the gutter 32 is recovered in the ink tank 28 via the first ink recovery flow path 34 to be reused.

As described above, also in the ink jet recording apparatus of the present embodiment, an image is recorded on a recording medium by ejecting an ink droplet continuously through an application of an electrostatic force to ink, and by controlling the behavior of ink droplets with the deflecting means in accordance with an image signal, whereby an image can be recorded under such a condition that ink droplets are ejected from the ejection head at a high ejection frequency at all times, the response to an image signal is enhanced, and a recording frequency can be increased.

Furthermore, even in the ink jet recording apparatus of the present embodiment, an electrostatic force is applied to ink to allow ink droplets to be ejected, whereby droplets with a minute droplet diameter can be ejected stably at a high ejection frequency, and an image of high quality can be formed stably at high speed.

Herein, in the above-mentioned first and second embodiments, a predetermined electric field is formed between the ejection heads 20 and 50 and the counter electrode 22, whereby ink droplets are ejected. However, the present invention is not limited thereto. Ink droplets may be ejected by the action of a predetermined electric field formed between each ejection head and the back electrode without providing the counter electrode.

Furthermore, in the ink jet recording apparatus of the above-mentioned embodiments, as described above, it is preferable that conveying means such as a conveyor belt be provided, for example, at the back electrode, and an image be recorded while conveying the recording medium P in a direction orthogonal to the arrangement direction of the ejection ports placed in a single line structure. However, the present invention is not limited thereto. Needless to say, the configuration may be such that conveying means is not provided.

Furthermore, in the above embodiments, although ink droplets to be recovered in the gutter are deflected, the present invention is not limited thereto. For example, the following may be possible: the gutter is placed on a conveying path of ink droplets that are allowed to fly straight without being deflected, and ink droplets to be recovered in the gutter are allowed to fly straight while deflecting ink droplets to be allowed to land on a recording medium.

Furthermore, in the above embodiments, it is preferable to use ink in which particles having electrical charges are dispersed in a solvent having a high electric resistance in view of ejecting ink with colorant concentrated to form an image with less blur. However, the present invention is not limited thereto. Various kinds of ink can be used as long as the ink has an electrical charge as a whole, i.e., the ink contains at least fine particles and a solvent and has an electrical charge. For example, ink which is prepared by using a solvent with colorant particles that are unlikely to be charged and has appropriate conductivity owing to a charge control agent or a conductive agent may be used. In this case, the ink is ejected as fine droplets by applying an electrostatic force to an ink solvent without having colorant particles being concentrated.

More specifically, it is possible to use ink obtained by dispersing colorant particles, which are unlikely to be charged, in a solvent with a low electrical resistivity (10⁹ Ω·cm or less), for example, water or a polar organic solvent (alcohol, ketone, ester, ether, amide). In this case, the solvent having a low electrical resistivity is put in a state having an electrical charge. Through an application of an electrostatic force to the ink, the solvent having an electrical charge can be ejected as a droplet together with colorant particles.

Furthermore, it is also possible to use ink obtained by dispersing colorant particles having an electrical charge in a solvent with a low electrical resistivity. In this case, the solvent and the colorant particles are put in a state having an electrical charge. Through an application of an electrostatic force to the ink, the solvent and the colorant particles having an electrical charge can be ejected as a droplet.

Furthermore, it is also possible to use ink obtained by adding a conductive agent to the above-mentioned solvent with a high electrical resistivity (10⁹ Ω·cm or more), and dispersing colorant particles that are unlikely to be charged. Thus, even in a case of using such a solvent with a high electrical resistivity, the solvent is put in a state having an electrical charge by applying a conductive agent to the solvent. Thus, through an application of an electrostatic force to the ink, the solvent having an electrical charge can be ejected as a droplet together with colorant particles.

Furthermore, it is also possible to use ink obtained by adding a conductive agent to a solvent having a high electrical resistivity and dispersing colorant particles having an electrical charge. In this case, the conductive agent in the solvent and the colorant particles having an electrical charge are put in a state having an electrical charge. Thus, through an application of an electrostatic force, the solvent and the colorant particles having an electrical charge can be ejected as a droplet.

Furthermore, in the present embodiments, although ink has colorant particles as fine particles, the present invention is not limited thereto. A solution having various kinds of fine particles such as colorless resin particles can be used.

Herein, as the solution having various kinds of fine particles such as colorless rein particles, the above-mentioned carrier liquid, dispersion resin particles, charge control agent or the like can be used, and the solution can be produced by selecting and mixing the above-mentioned carrier liquid, dispersion resin particles, charge control agent, and/or other various kinds of materials, if required.

Furthermore, the above embodiments have been described using the ink jet recording apparatus, the fine droplet ejecting device of the present invention is not limited thereto. For example, it can be used for a microchemical reaction apparatus, a micro drug analysis apparatus, a coating apparatus, or the like.

Although the fine droplet ejecting device and the ink jet recording apparatus of the present invention have been described in detail, the present invention is not limited to the above embodiments. It should be appreciated that the present invention may be variously modified and altered within the scope of not departing from the gist of the present invention.

For example, in the present invention, although multiple ejection ports of the ejection head are placed, only one ejection port may be used. Furthermore, in the case of placing multiple ejection ports of the ejection head, the opening of the counter electrode may be formed in one slit shape so as to be shared by the multiple ejection ports.

What is claimed is:

1. A fine droplet ejecting device for ejecting fine droplets by applying an electrostatic force to a solution having an electrical charge containing at least fine particles and a medium, comprising:
ejection means having an ejection port, said ejection means for continuously ejecting said fine droplets from said ejection port by applying the electrostatic force to said solution;
deflecting means for deflecting said fine droplets ejected from said ejection means based on a control signal; and
recovering means for recovering either one of the fine droplets flying straight after being ejected from said ejection means and the fine droplets having a flight direction deflected by said deflecting means.

2. The fine droplet ejecting device according to claim 1, wherein said ejection means further comprises resolution enhancing means for deflecting said fine droplets in a direction different from said flight direction deflected by said deflecting means.

3. The fine droplet ejecting device according to claim 2, wherein said resolution enhancing means deflect said fine droplets by applying the electrostatic force to at least one of said solutions and said fine droplets.

4. The fine droplet ejecting device according to claim 2, wherein said resolution enhancing means deflect said fine droplets in plural directions periodically.

5. The fine droplet ejecting device according to claim 2, wherein said resolution enhancing means have a first control electrode and a second control electrode placed in parallel around said ejection port, and a control unit for controlling a voltage applied to said first control electrode and said second control electrode.

6. The fine droplet ejecting device according to claim 1, wherein said ejection means have plural ejection ports.

7. The fine droplet ejecting device according to claim 1, wherein said fine particles are charged fine particles having an electrical charge.

8. The fine droplet ejecting device according to claim 1, wherein said fine particles contain an electrical charge and a colorant.

9. An ink jet recording apparatus using a fine droplet ejecting device for ejecting fine droplets by applying an electrostatic force to a solution having an electrical charge containing at least fine particles and a medium, comprising:
ejection means having an ejection port, said ejection means for continuously ejecting said fine droplets from said ejection port by applying the electrostatic force to said solution;
deflecting means for deflecting said fine droplets ejected from said ejection means based on a control signal; and
recovering means for recovering either one of the fine droplets flying straight after being ejected from said ejection means and the fine droplets having a flight direction deflected by said deflecting means,
wherein said solution is ink,
said deflecting means deflects said fine droplets ejected from said ejection means based on said control signal in accordance with an image signal, thereby landing either one of said fine droplets flying straight after being ejected by said ejection means and said fine droplets having said flight direction deflected by said deflecting means on a recording medium, and
said recovering means recovers said fine droplets that is not landed on said recording medium, whereby an image based on said image signal is formed on said recording medium.

10. The ink jet recording apparatus according to claim 9, wherein said ejection means includes an ejection portion having said ejection port and a counter electrode for forming a predetermined electric field between said counter electrode and said ejection portion, said counter electrode being placed between said ejection portion and said deflecting means.

11. The ink jet recording apparatus according to claim 10, wherein said counter electrode have an opening on a flight path of said fine droplets.

12. The ink jet recording apparatus according to claim 9, further comprising a back electrode for forming a predetermined electric field between said back electrode and said ejection means, said back electrode being placed at a position opposed to said ejection means across said deflecting means.

13. The ink jet recording apparatus according to claim 9, wherein said deflecting means is means for applying an electric field or a magnetic field for deflecting the flying fine droplets.

14. The ink jet recording apparatus according to claim 9, wherein said deflecting means is means for generating an air stream for deflecting the flying fine droplets.

15. The ink jet recording apparatus according to claim 9, further comprising circulation means for supplying said ink to said ejection means and recovering the ink that is not ejected by said ejection means.

16. The ink jet recording apparatus according to claim 15, further comprising recovered ink supply means for supplying said ink recovered by said recovering means to said circulation means.

17. The ink jet recording apparatus according to claim 9, further comprising ink concentration adjusting means for adjusting an ink concentration of said ink.
